(19) United States
(12) Patent Application Publication
(10) Pub. No.: US 2023/0341727 A1
(43) Pub. Date: Oct. 26, 2023

(54) WAVELENGTH CONVERSION MEMBER, METHOD FOR PRODUCING WAVELENGTH CONVERSION MEMBER, LIGHT EMITTING DEVICE, AND LIQUID CRYSTAL DISPLAY DEVICE

(71) Applicant: FUJIFILM Corporation, Tokyo (JP)

(72) Inventor: Tatsuya OBA, Kanagawa (JP)

(73) Assignee: FUJIFILM Corporation, Tokyo (JP)

(21) Appl. No.: 18/334,882

(22) Filed: Jun. 14, 2023

Related U.S. Application Data
(63) Continuation of application No. PCT/JP2021/046726, filed on Dec. 17, 2021.

(30) Foreign Application Priority Data
Dec. 17, 2020 (JP) 2020-209461

(51) Int. Cl. G02F 1/1335; C09K 11/02; C09K 11/06

(52) U.S. Cl. CPC G02F 1/133614; C09K 11/02; C09K 11/06; G02F 2202/36; C09K 2211/1018; C09K 2211/1007

(57) ABSTRACT

Provided is a wavelength conversion member including a wavelength conversion layer and a substrate, in which the wavelength conversion layer contains a binder and microparticles, and the microparticles contain a pyrromethene derivative and a matrix.

### CROSS-REFERENCE TO RELATED APPLICATIONS

This application is a Continuation of PCT International Application No. PCT/JP2021/046726 filed on Dec. 17, 2021, which claims priority under 35 U.S.C. § 119(a) to Japanese Patent Application No. 2020-209461 filed on Dec. 17, 2020. Each of the above applications is hereby expressly incorporated by reference, in its entirety, into the present application.

### BACKGROUND OF THE INVENTION

### 1. Field of the Invention

The present invention relates to a wavelength conversion member, a method for producing a wavelength conversion member, a light emitting device, and a liquid crystal display device.

### 2. Description of the Related Art

A flat panel display such as a liquid crystal display device (hereinafter, also referred to as LCD) is used as a space-saving image display apparatus with low power consumption, and its application is expanding year by year. The liquid crystal display device is usually composed of at least a light emitting device and a liquid crystal cell.

In recent years, improvement in color reproducibility by means of wavelength conversion has been actively studied for flat panel displays. In order to improve the color reproducibility, it is effective to narrow a half-width of each of blue, green, and red emission spectra of a backlight unit to increase the color purity of each color of blue, green, and red. This makes it possible for the obtained white light to have high brightness. Quantum dots made of inorganic semiconductor fine particles (see, for example, JP2013-544018A) and various light emitting materials (see, for example, WO2016/190283A, WO2018/101129A, WO2018/117095A, and WO2018/221216A) have been proposed as means for achieving such a purpose.

### SUMMARY OF THE INVENTION

The light emitting material described in JP2013-544018A and the light emitting material described in WO2016/190283A have narrow half-widths of green and red emission spectra and improved color reproducibility, but do not have sufficient durability against heat, and moisture and/or oxygen in the air.

An organic light emitting material may be degraded by singlet oxygen and/or radicals generated by light irradiation. On the other hand, WO2018/101129A discloses that the durability is improved by using a specific pyrromethene derivative as the structure of an organic light emitting material and reducing a free volume of a resin that serves as a binder for the light emitting material. On the other hand, WO2018/117095A discloses that a quantum dot material is made into microparticles which are then dispersed in a resin having high oxygen barrier properties to improve the durability.

Regarding a pyrromethene derivative light emitting material, WO2018/221216A discloses that higher color purity can be obtained by containing each of a red light emitting material and a green light emitting material in different layers to form a laminate, rather than by containing the red light emitting material and the green light emitting material in the same layer. However, in a case of being made into a laminate and then in a case where a composition containing two types of organic light emitting materials is continuously applied onto a substrate, the organic light emitting materials are mixed in the vicinity of the interface, so it is difficult to maintain high color purity in the related art. On the other hand, the method of independently producing two layers containing different organic light emitting materials and bonding the two layers to each other requires a complicated process.

An object of one aspect of the present invention is to provide a wavelength conversion member that can achieve both high color purity and durability and can be easily produced, as well as a light emitting device and a liquid crystal display device, each of which uses the wavelength conversion member.

One aspect of the present invention relates to a wavelength conversion member including a wavelength conversion layer and a substrate, in which the wavelength conversion layer contains a binder and microparticles, and the microparticles contain a pyrromethene derivative and a matrix.

In one embodiment, an oxygen permeability coefficient of the binder can be 0.01 (cc·mm)/(m²·day·atm) or less.

In one embodiment, the wavelength conversion layer can contain 0.01% to 5% by mass of an emulsifier.

In one embodiment, an average particle diameter of the microparticles can be 1 μm or more and 15 μm or less.

In one embodiment, the wavelength conversion layer can contain microparticles 34G containing a pyrromethene derivative exhibiting light emission by using excitation light, in which a peak wavelength is observed in a region of 500 nm or more and 580 nm or less, and microparticles 34R containing a pyrromethene derivative exhibiting light emission by using excitation light, in which a peak wavelength is observed in a region of 580 nm or more and 750 nm or less.

In one embodiment, the wavelength conversion member can include a laminate 26Y of a wavelength conversion layer 26G containing the microparticles 34G and a wavelength conversion layer 26R containing the microparticles 34R.

In one embodiment, the wavelength conversion member can have, as the wavelength conversion layer, a layer containing the microparticles 34G and the microparticles 34R in the same layer.

One aspect of the present invention relates to a method for producing a wavelength conversion member including applying a composition containing the microparticles 34G onto a substrate to form a wavelength conversion layer 26G, and applying a composition containing the microparticles 34R onto the wavelength conversion layer 26G to form a wavelength conversion layer 26R and form a laminate 26Y.

One aspect of the present invention relates to a light emitting device including the wavelength conversion member and a light source.

In one embodiment, the light source can be selected from the group consisting of a blue light emitting diode and an ultraviolet light emitting diode.

One aspect of the present invention relates to a liquid crystal display device including the light emitting device and a liquid crystal cell.

According to one aspect of the present invention, it is possible to provide a wavelength conversion member that can achieve both high color purity and durability and can be easily produced. According to another aspect of the present invention, it is possible to provide a light emitting device including the wavelength conversion member, and a liquid crystal display device including the light emitting device.

### BRIEF DESCRIPTION OF THE DRAWINGS

FIG. 1 is a conceptual diagram showing an example of a backlight unit using a wavelength conversion member according to one aspect of the present invention.

FIG. 2 is a conceptual diagram showing a configuration of a wavelength conversion member 16.

### DESCRIPTION OF THE PREFERRED EMBODIMENTS

The following description may be based on representative embodiments of the present invention. However, the present invention is not limited to such embodiments. In the present invention and the present specification, any numerical range expressed by using “to” refers to a range including the numerical values before and after the “to” as a lower limit value and an upper limit value, respectively.

In the present invention and the present specification, the “microparticle” means a particle having a particle diameter in a range of 50 nm or more and 500 μm or less. The average particle diameter of the microparticles contained in the wavelength conversion layer is preferably 0.5 μm or more and 20 μm or less, and more preferably 1 μm or more and 15 μm or less. The particle diameter and the average particle diameter will be described later. The shape of the microparticle is not particularly limited and may be any shape such as a true spherical shape, an elliptical shape, and an amorphous shape.

In addition, in the present invention and the present specification, “(meth)acrylate” is used to indicate one or both of acrylate and methacrylate. The same applies to “(meth)acryloyl” and the like.

[Wavelength Conversion Member]

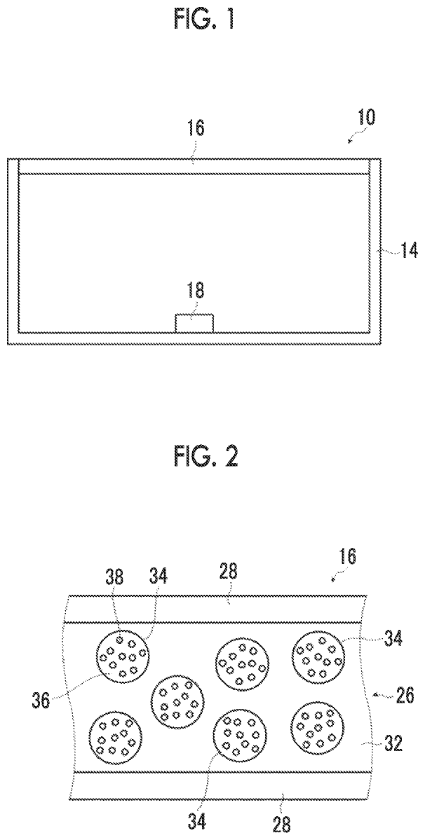

FIG. 1 conceptually shows an example of a backlight unit using the wavelength conversion member according to one aspect of the present invention.

A backlight unit 10 is a direct type planar backlight unit (planar lighting device) used for a backlight of a liquid crystal display device or the like, and is configured to have a housing 14, a wavelength conversion member 16, and a light source 18. The wavelength conversion member 16 is the wavelength conversion member according to one aspect of the present invention.

In the following description, the “liquid crystal display device” is also referred to as “LCD”. It should be noted that “LCD” is an abbreviation for “Liquid Crystal Display”.

In addition, FIG. 1 is merely a schematic diagram, and the backlight unit 10 may have various known members provided in a known backlight unit such as a backlight of an LCD, for example, one or more of a light emitting diode (LED) substrate, a wiring line, and a heat radiation mechanism, in addition to the illustrated members.

The housing 14 is, for example, a rectangular housing whose maximum surface is open, and the wavelength conversion member 16 is disposed to close the opening surface. The housing 14 is a known housing used for a backlight unit of an LCD or the like.

In addition, as a preferred form, at least a bottom surface of the housing 14, which is an installation surface of the light source 18, is a light reflecting surface selected from a mirror surface, a metal reflecting surface, a diffuse reflecting surface, and the like. Preferably, the entire inner surface of the housing 14 is a light reflecting surface.

The wavelength conversion member 16 is a wavelength conversion member that receives light emitted from the light source 18, converts the wavelength of the light, and emits the wavelength-converted light. As described above, the wavelength conversion member 16 is the wavelength conversion member according to one aspect of the present invention. The wavelength conversion member 16 has at least a wavelength conversion layer and a substrate. The substrate can support the wavelength conversion layer.

FIG. 2 conceptually shows a configuration of the wavelength conversion member 16. The wavelength conversion member 16 has a wavelength conversion layer 26 and a substrate 28 that sandwiches and supports the wavelength conversion layer 26.

In addition, the wavelength conversion layer 26 has a binder 32 and microparticles 34 dispersed in the binder 32. The microparticles 34 contain a pyrromethene derivative 38 and a matrix 36, and the pyrromethene derivative 38 is dispersed in the matrix 36.

<Wavelength Conversion Layer>

The wavelength conversion layer 26 has a function of converting the wavelength of the incident light and emitting the wavelength-converted light. For example, in a case where blue light emitted from the light source 18 is incident on the wavelength conversion layer 26, the wavelength conversion layer 26 carries out wavelength conversion of at least a part of the blue light into red light or green light due to the effect of the pyrromethene derivative 38 contained inside the wavelength conversion layer 26 and emits the wavelength-converted light. Here, the blue light is light having a light emission center wavelength in a wavelength range of 400 to 500 nm. The green light is light having a light emission center wavelength in a wavelength range of more than 500 nm and 580 nm or less. The red light is light having a light emission center wavelength in a wavelength range of more than 580 nm and 750 nm or less.

For example, in a case where blue light is incident as excitation light, white light can be realized by green light emitted by a pyrromethene derivative (G), red light emitted by a pyrromethene derivative (R), and blue light transmitted through the wavelength conversion layer.

<Microparticles and Binder>

The pyrromethene derivative can be uniformly dispersed or may be unevenly dispersed in the microparticles 34. It is preferable that the pyrromethene derivative is uniformly dispersed in the microparticles 34. In addition, only one type of pyrromethene derivative may be used, or two or more types of pyrromethene derivatives may be used in combination. In a case where two or more types of pyrromethene derivatives are used in combination, two or more types of pyrromethene derivatives having different wavelengths of emitted light may be used.

The wavelength conversion layer 26 is formed by dispersing and fixing the microparticles 34, which are formed by dispersing the pyrromethene derivative in the matrix 36, in the binder 32. By individually encapsulating two or more different pyrromethene derivatives in the microparticles, it is possible to reduce the mixing of the pyrromethene derivatives even in a case where the compositions containing the pyrromethene derivatives are sequentially applied.

In one embodiment, the wavelength conversion member 16 can contain two or more different pyrromethene derivatives having different light-emitting properties. In one example of the specific embodiment, the wavelength conversion member 16 contains two types of pyrromethene derivatives having different light-emitting properties, and these two types of pyrromethene derivatives can be contained in the same wavelength conversion layer. In another example of the specific embodiment, the wavelength conversion member 16 contains two different pyrromethene derivatives having different light-emitting properties, and these two types of pyrromethene derivatives can be contained in the different wavelength conversion layers.

The two types of pyrromethene derivatives having different light-emitting properties can be a pyrromethene derivative exhibiting light emission by using excitation light, in which a peak wavelength is observed in a region of 500 nm or more and 580 nm or less, and a pyrromethene derivative exhibiting light emission by using excitation light, in which a peak wavelength is observed in a region of 580 nm or more and 750 nm or less.

In one example of the above-described specific embodiment, the wavelength conversion member 16 can contain, in the same wavelength conversion layer, for example, microparticles 34G containing a pyrromethene derivative exhibiting light emission by using excitation light, in which a peak wavelength is observed in a region of 500 nm or more and 580 nm or less, and microparticles 34R containing a pyrromethene derivative exhibiting light emission by using excitation light, in which a peak wavelength is observed in a region of 580 nm or more and 750 nm or less.

In another example of the above-described specific embodiment, the wavelength conversion member 16 can include, for example, a laminate 26Y of a wavelength conversion layer 26G containing the microparticles 34G and a wavelength conversion layer 26R containing the microparticles 34R.

The formation of the laminate 26Y is preferably carried out by applying a composition containing the microparticles 34G onto a substrate to form the wavelength conversion layer 26G, and further applying a composition containing the microparticles 34R onto the wavelength conversion layer 26G to form the wavelength conversion layer 26R. In a case where the coating layers are sequentially applied in this manner, it is not necessary to separately form the wavelength conversion layers 26G and 26R into films and bond the two films together, so the process can be simplified.

The film thickness of the wavelength conversion layer 26 is not particularly limited and may be appropriately set depending on the thickness of the wavelength conversion member 16, the pyrromethene derivative which is the pyrromethene derivative 38 to be used, the binder 32 to be used, and the like.

In one embodiment, the film thickness of the wavelength conversion layer 26 is preferably in a range of 10 to 1,000 and more preferably in a range of 15 to 100 Setting the film thickness of the wavelength conversion layer 26 to 10 μm or more is preferable in terms of being capable of obtaining the wavelength conversion layer 26 that emits light having sufficient brightness, and in terms of improving the tint distribution and the brightness distribution resulting from the film thickness distribution of the wavelength conversion layer 26.

In the wavelength conversion layer, the oxygen permeability coefficient of the binder 32 in which the microparticles 34 are dispersed is preferably 0.01 (cc·mm)/(m²·day·atm) or less. In order to prevent a phosphor from being deteriorated by oxygen, it is preferable to use a material having high gas barrier properties as the matrix for forming the microparticles containing the phosphor. Generally, a phosphor having a high luminous efficacy is hydrophobic. Therefore, it is preferable to use a hydrophobic material as the matrix in order to retain a sufficient amount of the phosphor in the microparticles in a properly dispersed state without aggregation in the matrix. However, the hydrophobic material has high compatibility with oxygen, so higher hydrophobicity leads to a higher oxygen permeability coefficient of the material, that is, lower gas barrier properties of the material. On the contrary, higher hydrophilicity leads to a lower oxygen permeability coefficient of the material, that is, higher gas barrier properties of the material. As described above, in a case of the material serving as the matrix, there is a trade-off relationship between the dispersibility of the phosphor and the gas barrier properties. On the other hand, in a case where the microparticles formed of a hydrophobic matrix are used, it is preferable to use a hydrophilic material as the binder in order to increase the amount of the microparticles to be contained in the wavelength conversion layer and to properly disperse the microparticles encapsulating the phosphor in the binder. As described above, the higher hydrophilicity of the material leads to a lower oxygen permeability coefficient of the material, that is, higher gas barrier properties of the material. However, in a case where the microparticles are formed of a hydrophobic material, that is, a material having low gas barrier properties, and then in a case where the amount of the microparticles is too large, the gas barrier properties of the wavelength conversion layer are lowered and therefore the deterioration of the phosphor due to oxygen cannot be prevented. It is preferable that the oxygen permeability coefficient of the binder 32 is 0.01 (cc·mm)/(m²·day·atm) or less from the viewpoint of preventing deterioration of the pyrromethene derivative 38 due to oxygen. The oxygen permeability coefficient of the binder 32 is more preferably 0.005 (cc·mm)/(m²·day·atm) or less. It is preferable that the oxygen permeability coefficient of the binder 32 is lower. Therefore, the lower limit of the oxygen permeability coefficient of the binder 32 is not particularly limited.

The SI unit of the oxygen permeability coefficient is [fm·mm/(s·Pa)]. “fm” is “femtometer” and “1 fm=1×10⁻¹⁵ m”. The SI units [fm·mm/(s·Pa)] and [cc·mm/(m²·day·atm)] can be converted into “1 fm·mm/(s·Pa)=8.752 cc·mm/(m²·day·atm)”.

In addition, the oxygen permeability coefficient and the oxygen permeability can be measured, for example, by the method according to JIS K 7126 (equal pressure method) and the method shown in ASTM D3985, and may be measured using an oxygen permeability measuring device of MOCON, Inc. or a measuring device (for example, manufactured by Nippon API Co., Ltd.) according to the atmospheric pressure ionization mass spectrometry (APIMS) under conditions of a temperature of 25° C. and a relative humidity of 60%.

The material for forming the binder 32 is also not particularly limited, and various known materials can be used as long as those materials preferably have an oxygen permeability coefficient of 0.01 (cc·mm)/(m²·day·atm) or less and can hold and fix the microparticles 34. Preferably, various resins are used.

Specific examples of the material for forming the binder 32 include a polyvinyl alcohol (PVA), a modified PVA having a substituent such as a vinyl group or a (meth)acryloyl group, an ethylene-vinyl alcohol copolymer (EVOH), a butenediol-vinyl alcohol copolymer (BVOH), a polyvinylidene chloride, and an aromatic polyamide (aramid). PVA and modified PVA are suitable examples of the material for forming the binder 32 because these materials have a low oxygen permeability coefficient and excellent temporal stability of solution.

Generally, PVA is obtained by using polyvinyl acetate obtained by polymerizing vinyl acetate as a raw material, saponifying the polyvinyl acetate, and substituting an acetyl group with a hydroxy group. Due to this synthetic process, PVA has acetyl groups and hydroxy groups, the ratio of which is expressed as a degree of saponification. The degree of saponification in the present invention and the present specification is the same as the definition of the degree of saponification known in the art, and refers to a ratio (mol %) of the number of moles of vinyl alcohol units to the total number of moles of structural units (typically, vinyl ester units) that can be converted into vinyl alcohol units by saponification and vinyl alcohol units. In particular, in a case where polyvinyl acetate is used as a raw material, the degree of saponification means a value obtained by dividing the number of hydroxy groups derived from the vinyl alcohol skeleton contained in PVA by the sum of the number of acetyl groups derived from the vinyl acetate skeleton and the number of hydroxy groups derived from the vinyl alcohol skeleton.

From the viewpoint of the oxygen permeability coefficient, the degree of saponification of PVA and modified PVA is preferably 70 mol % or more, more preferably 80 mol % or more, and still more preferably 90 mol % or more. In addition, the upper limit of the degree of saponification is preferably 99 mol % or less from the viewpoint of not impairing the dispersibility of the microparticles.

The modifying group of the modified PVA can be introduced by copolymerization modification, chain transfer modification, or block polymerization modification. Examples of the modifying group include a hydrophilic group (a carboxylic acid group, a sulfonic acid group, a phosphonic acid group, an amino group, an ammonium group, an amide group, a thiol group, or the like), a hydrocarbon group having 10 to 100 carbon atoms, a fluorine atom-substituted hydrocarbon group, a thioether group, a polymerizable group (an unsaturated polymerizable group, an epoxy group, an aziridinyl group, or the like), and an alkoxysilyl group (trialkoxysilyl group, dialkoxysilyl group, or monoalkoxysilyl group). Specific examples of the modified PVA include those described in, for example, paragraph [0074] of JP2000-56310A, paragraphs [0022] to [0145] of JP2000-155216A, and paragraphs [0018] to [0022] of JP2002-62426A.

In addition, the weight-average molecular weight (Mw) of the binder resin can be preferably 5,000 or more, more preferably 15,000 or more, and still more preferably 20,000 or more and can be preferably 500,000 or less, more preferably 100,000 or less, and still more preferably 50,000 or less. In a case where the weight-average molecular weight is within the above range, a wavelength conversion member having good compatibility with the microparticles and having higher durability can be obtained.

The weight-average molecular weight in the present invention and the present specification is a value measured by gel permeation chromatography (GPC). Specifically, the weight-average molecular weight is a value in terms of polystyrene obtained by filtering a sample through a membrane filter having a pore diameter of 0.45 μm and then carrying out GPC (HLC-82A manufactured by Tosoh Corporation) (development solvent: toluene, development rate: 1.0 ml/min, column: TSKgel G2000HXL manufactured by Tosoh Corporation).

In the binder 32, only one type of resin may be used, or a plurality of resins may be used in combination. In addition, a commercially available product may be used as the binder 32.

In the wavelength conversion member, the content of the microparticles 34 in the wavelength conversion layer 26 is preferably in a range of 3% to 30% by volume. It is preferable that the content of the microparticles 34 in the wavelength conversion layer 26 is 3% by volume or more from the viewpoint of obtaining light emission having sufficient brightness, and from the viewpoint of thinning the wavelength conversion layer 26, that is, the wavelength conversion member 16. It is preferable that the content of the microparticles 34 in the wavelength conversion layer 26 is 30% by volume or less from the viewpoint of further preventing deterioration of the pyrromethene derivative 38 due to oxygen, and from the viewpoint of properly dispersing the microparticles 34 in the wavelength conversion layer 26. The content of the microparticles 34 in the wavelength conversion layer 26 is more preferably in a range of 5% to 25% by volume. The content of the microparticles 34 in the wavelength conversion layer 26 can be measured by cutting the wavelength conversion layer 26 with a microtome or the like to form a cross section, and analyzing an image obtained by observing the cross section using an optical microscope.

The binder 32 of the wavelength conversion layer 26 may further contain an emulsifier. Preferably, the wavelength conversion layer 26 can contain preferably 0.01% to 5% by mass, more preferably 0.05% to 3% by mass of an emulsifier.

The binder 32 preferably contains an emulsifier such that the wavelength conversion layer 26 contains 0.01% by mass or more of the emulsifier from the viewpoint that it is possible to obtain the wavelength conversion member 16 having excellent optical properties with less chromaticity unevenness and brightness unevenness in light emission by improving the dispersion state of the microparticles 34 in the wavelength conversion layer 26, and from the viewpoint that it is possible to sharpen the particle size distribution of the microparticles 34.

In a case where the binder 32 contains an emulsifier, it is preferable that the content of the emulsifier in the wavelength conversion layer 26 is 5% by mass or less from the viewpoint of preventing deterioration of the gas barrier properties of the wavelength conversion layer 26.

The emulsifier to be added to the wavelength conversion layer 26 is not particularly limited, and various known emulsifiers can be used. Preferably, an emulsifier having a hydrophile-lipophile balance (HLB) value of 8 to 19 or 8 to 18 can be used. In one embodiment, more preferably, an emulsifier having an HLB value of 10 to 16 can be used as the emulsifier to be added to the wavelength conversion layer 26. Examples of the method for calculating the HLB value include a Griffin method and a Davies method. In the present invention and the present specification, a value calculated by the Griffin method is used as the HLB value. In the Griffin method, the HLB value is obtained by the following expression based on the formula weight and the molecular weight of hydrophilic groups. Therefore, the HLB value in this case has a value in a range of 0 to 20.

HLB value=20×(sum of formula weights of hydrophilic groups/molecular weight)

In one embodiment, the range of the HLB value is preferably in a range of 5 to 19, more preferably in a range of 7 to 18, and still more preferably in a range of 8 to 17. It is preferable that the HLB value is within the above range from the viewpoint of improving the dispersibility of the microparticles in the binder.

Examples of the emulsifier include a cationic surfactant, an anionic surfactant, and a nonionic surfactant. An anionic surfactant and a nonionic surfactant are particularly preferable from the viewpoint of not inhibiting the dispersibility of the pyrromethene derivative. Specifically, it is preferable to use an alkyl sulfate as the anionic surfactant from the viewpoint that it has less odor, has good biodegradability, and is relatively environmentally friendly. Specific examples of the alkyl sulfate include alkyl sulfates such as sodium octyl sulfate (SOS) (which has 8 carbon atoms), sodium decyl sulfate (which has 10 carbon atoms), and sodium dodecyl sulfate (SDS) (which has 12 carbon atoms). In addition, examples of the nonionic surfactant include ether-based surfactants such as polyethylene glycol dodecyl ether, polyethylene glycol octadecyl ether, polyethylene glycol oleyl ether, polyoxyethylene nonylphenyl ether, polyoxyethylene octylphenyl ether, polyoxyethylene dodecylphenyl ether, polyoxyethylene oleyl ether, polyoxyethylene lauryl ether, and polyoxyethylene alkyl ether; ester-based surfactants such as polyoxyethylene oleate, polyoxyethylene distearate, sorbitan laurate, sorbitan monostearate, sorbitan monooleate, sorbitan sesquioleate, polyoxyethylene monooleate, and polyoxyethylene stearate; acetylene alcohol-based surfactants such as 3,5-dimethyl-1-hexyn-3-ol; and acetylene glycol-based surfactants such as 2,4,7,9-tetramethyl-5-decyne-4,7-diol and 3,6-dimethyl-4-octyne-3,6-diol.

In addition, commercially available products such as BRIJ 30, BRIJ 35, BRIJ S10, BRIJ O20, and BRIJ 93 (all manufactured by Sigma-Aldrich Co. LLC) can also be suitably used as the nonionic surfactant.

In addition, the wavelength conversion layer 26 may contain, if necessary, a silane coupling agent, a crosslinking agent, a light scattering agent, a viscosity modifier, a surface modifier, an inorganic lamellar compound, or the like, in addition to the emulsifier.

The wavelength conversion layer 26 can be formed in such a manner that a dispersion liquid to be microparticles 34 is prepared, the dispersion liquid is put into an aqueous solution in which a compound to be the binder 32 such as PVA is dissolved, the matrix 36 is cured while stirring to prepare a coating liquid in which the microparticles 34 are dispersed and emulsified in the aqueous solution, and the coating liquid is applied onto the substrate 28 and then dried.

In the wavelength conversion member 16, the oxygen permeability coefficient of the matrix 36, which is a material for forming the microparticles 34, is preferably 10 to 1,000 (cc·mm)/(m²·day·atm). It is preferable that the oxygen permeability coefficient of the matrix 36 is 10 (cc·mm)/(m²·day·atm) or more in order to properly disperse and hold a sufficient amount of the pyrromethene derivative 38 in the matrix 36, that is, the microparticles 34 without aggregation. On the other hand, in a case where the pyrromethene derivative aggregates, there may be a problem such as a decrease in brightness of the wavelength conversion layer 26 due to the aggregation of the pyrromethene derivative. It is preferable that the oxygen permeability coefficient of the matrix 36 is 1,000 (cc·mm)/(m²·day·atm) or less from the viewpoint of improving the gas barrier properties of the wavelength conversion member 16. The oxygen permeability coefficient of the matrix 36 is more preferably in a range of 10 to 500 (cc·mm)/(m²·day·atm).

Various known materials can be used as the material for forming the matrix 36 of the microparticles 34 as long as those materials preferably have an oxygen permeability coefficient of 10 to 1,000 (cc·mm)/(m²·day·atm). Various resins are preferably used as the material for forming the matrix 36.

As an example, a matrix 36 obtained by curing (polymerizing or crosslinking) a monofunctional (meth)acrylate monomer and/or a polyfunctional (meth)acrylate monomer can be exemplified as the matrix 36. Examples of the monofunctional (meth)acrylate monomer include an acrylic acid, a methacrylic acid, and derivatives thereof, and more specifically, an aliphatic or aromatic monomer having one polymerizable unsaturated bond (meth)acryloyl group of (meth)acrylic acid in the molecule and having an alkyl group having 1 to 30 carbon atoms. Compounds are listed below as specific examples thereof. However, the present invention is not limited thereto.

Examples of the aliphatic monofunctional (meth)acrylate monomer include alkyl (meth)acrylates with an alkyl group having 1 to 30 carbon atoms, such as methyl (meth)acrylate, n-butyl (meth)acrylate, isobutyl (meth)acrylate, 2-ethylhexyl (meth)acrylate, isononyl (meth)acrylate, n-octyl (meth)acrylate, lauryl (meth)acrylate, and stearyl (meth)acrylate; alkoxyalkyl (meth)acrylates with an alkoxyalkyl group having 2 to 30 carbon atoms, such as butoxyethyl (meth)acrylate; aminoalkyl (meth)acrylates with a (monoalkyl or dialkyl) aminoalkyl group having 1 to 20 carbon atoms in total, such as N,N-dimethylaminoethyl (meth)acrylate; (meth)acrylates of polyalkylene glycol alkyl ether with an alkylene chain having 1 to 10 carbon atoms and a terminal alkyl ether having 1 to 10 carbon atoms, such as (meth)acrylate of diethylene glycol ethyl ether, (meth)acrylate of triethylene glycol butyl ether, (meth)acrylate of tetraethylene glycol monomethyl ether, (meth)acrylate of hexaethylene glycol monomethyl ether, monomethyl ether (meth)acrylate of octaethylene glycol, monomethyl ether (meth)acrylate of nonaethylene glycol, monomethyl ether (meth)acrylate of dipropylene glycol, monomethyl ether (meth)acrylate of heptapropylene glycol, and monoethyl ether (meth)acrylate of tetraethylene glycol; (meth)acrylates of polyalkylene glycol aryl ether with an alkylene chain having 1 to 30 carbon atoms and a terminal aryl ether having 6 to 20 carbon atoms, such as (meth)acrylate of hexaethylene glycol phenyl ether; (meth)acrylates having 4 to 30 carbon atoms in total, having an alicyclic structure, such as cyclohexyl (meth)acrylate, dicyclopentanyl (meth)acrylate, isobornyl (meth)acrylate, and methylene oxide-added cyclodecatriene (meth)acrylate; fluorinated alkyl (meth)acrylates having 4 to 30 carbon atoms in total, such as heptadecafluorodecyl (meth)acrylate; (meth)acrylates having a hydroxy group, such as 2-hydroxyethyl (meth)acrylate, 3-hydroxypropyl (meth)acrylate, 4-hydroxybutyl (meth)acrylate, mono(meth)acrylate of triethylene glycol, tetraethylene glycol mono(meth)acrylate, hexaethylene glycol mono(meth)acrylate, octapropylene glycol mono(meth)acrylate, and mono(meth)acrylate of glycerol; (meth)acrylates having a glycidyl group, such as glycidyl (meth)acrylate; polyethylene glycol mono(meth)acrylates with an alkylene chain having 1 to 30 carbon atoms, such as tetraethylene glycol mono(meth)acrylate, hexaethylene glycol mono(meth)acrylate, and octapropylene glycol mono(meth)acrylate; and (meth)acrylamides such as (meth)acrylamide, N,N-dimethyl (meth)acrylamide, N-isopropyl (meth)acrylamide, 2-hydroxyethyl (meth)acrylamide, and acryloylmorpholine. Examples of the aromatic monofunctional acrylate monomer include aralkyl (meth)acrylate with an aralkyl group having 7 to 20 carbon atoms, such as benzyl (meth)acrylate.

Above all, an aliphatic or aromatic alkyl (meth)acrylate with an alkyl group having 4 to 30 carbon atoms is preferable, and n-octyl (meth)acrylate, lauryl (meth)acrylate, stearyl (meth)acrylate, cyclohexyl (meth)acrylate, dicyclopentanyl (meth)acrylate, isobornyl (meth)acrylate, and methylene oxide-added cyclodecatriene (meth)acrylate are more preferable. This is because the dispersibility of the pyrromethene derivative 38 in the microparticles 34 is improved. As the dispersibility of the pyrromethene derivative 38 is improved, the amount of light from the wavelength conversion layer 26 going straight to the emission surface is increased, which is effective in improving the front brightness and the front contrast.

Among the di- or higher polyfunctional (meth)acrylate monomers, preferred examples of the difunctional (meth)acrylate monomer include neopentyl glycol di(meth)acrylate, 1,6-hexanediol di(meth)acrylate, 1,9-nonanediol di(meth)acrylate, 1,10-decanediol diacrylate, tripropylene glycol di(meth)acrylate, ethylene glycol di(meth)acrylate, tetraethylene glycol di(meth)acrylate, neopentyl glycol hydroxypivalate di(meth)acrylate, polyethylene glycol di(meth)acrylate, tricyclodecanedimethanol diacrylate, and ethoxylated bisphenol A diacrylate.

Among the di- or higher polyfunctional (meth)acrylate monomers, preferred examples of the tri- or higher functional (meth)acrylate monomer include epichlorohydrin (ECH)-modified glycerol tri(meth)acrylate, ethylene oxide (EO)-modified glycerol tri(meth)acrylate, propylene oxide (PO)-modified glycerol tri(meth)acrylate, pentaerythritol triacrylate, pentaerythritol tetraacrylate, EO-modified phosphoric acid triacrylate, trimethylolpropane tri(meth)acrylate, caprolactone-modified trimethylolpropane tri(meth)acrylate, EO-modified trimethylolpropane tri(meth)acrylate, PO-modified trimethylolpropane tri(meth)acrylate, tris(acryloxyethyl) isocyanurate, dipentaerythritol hexa(meth)acrylate, dipentaerythritol penta(meth)acrylate, caprolactone-modified dipentaerythritol hexa(meth)acrylate, dipentaerythritol hydroxy penta(meth)acrylate, alkyl-modified dipentaerythritol penta(meth)acrylate, dipentaerythritol poly(meth)acrylate, alkyl-modified dipentaerythritol tri(meth)acrylate, ditrimethylolpropane tetra(meth)acrylate, pentaerythritol ethoxy tetra(meth)acrylate, and pentaerythritol tetra(meth)acrylate.

A (meth)acrylate monomer having a urethane bond in the molecule, specifically, an adduct of tolylene diisocyanate (TDI) and hydroxyethyl acrylate, an adduct of isophorone diisocyanate (IPDI) and hydroxyethyl acrylate, an adduct of hexamethylene diisocyanate (HDI) and pentaerythritol triacrylate (PETA), a compound obtained by reacting an adduct of TDI and PETA with the remaining isocyanate and dodecyloxyhydroxypropyl acrylate, an adduct of 6,6 nylon and TDI, an adduct of pentaerythritol, TDI, and hydroxyethyl acrylate, and the like can also be used as the polyfunctional monomer.

A plurality of these (meth)acrylate monomers may be used in combination. Further, a commercially available product may be used as the (meth)acrylate monomer.

In addition to the cured products of such (meth)acrylate monomers, a cured product of a silicone resin such as polydimethylsiloxane or polyorganosilsesquioxane, an acrylic resin, an epoxy resin, a polyimide resin, a urethane resin, a urea resin, a melamine resin, a polyamide resin, a polyamideimide resin, a polyester resin, a polyolefin resin, a polycarbonate resin, and the like can also be suitably used as the matrix 36 for forming the microparticles 34. One containing two or more types thereof or a copolymer thereof may be used as the matrix. For example, a copolymer of methyl methacrylate and an aliphatic polyolefin resin can be mentioned. Among these materials, an acrylic resin is preferable from the viewpoint of stability.

Examples of the acrylic resin include a polymer of an unsaturated carboxylic acid, and a copolymer of an unsaturated carboxylic acid and another ethylenically unsaturated compound. Among these resin compounds, a copolymer of an unsaturated carboxylic acid and an ethylenically unsaturated compound is preferable.

Examples of the unsaturated carboxylic acid include acrylic acid, methacrylic acid, itaconic acid, crotonic acid, maleic acid, fumaric acid, and vinyl acetic acid. Two or more thereof may be used as the unsaturated carboxylic acid.

Examples of the ethylenically unsaturated compound include an unsaturated carboxylic acid alkyl ester, an aliphatic vinyl compound, an aromatic vinyl compound, an unsaturated carboxylic acid aminoalkyl ester, an unsaturated carboxylic acid glycidyl ester, a carboxylic acid vinyl ester, a vinyl cyanide compound, an aliphatic conjugated diene, and a macromonomer. Examples of the unsaturated carboxylic acid alkyl ester include methyl acrylate, methyl methacrylate, ethyl acrylate, ethyl methacrylate, n-propyl acrylate, isopropyl acrylate, isopropyl methacrylate, n-propyl methacrylate, n-butyl acrylate, n-butyl methacrylate, sec-butyl acrylate, sec-butyl methacrylate, iso-butyl acrylate, iso-butyl methacrylate, tert-butyl acrylate, tert-butyl methacrylate, n-pentyl acrylate, n-pentyl methacrylate, 2-hydroxyethyl acrylate, 2-hydroxyethyl methacrylate, benzyl acrylate, and benzyl methacrylate. Examples of the aliphatic vinyl compound include ethylene, n-propylene, n-butene, n-pentene, n-hexene, vinyl cyclobutane, vinyl cyclopentane, and vinyl cyclohexane. “n-”, “sec-”, and “tert-” are abbreviations for “normal-”, “secondary-”, and “tertiary-”, respectively. Examples of the aromatic vinyl compound include styrene, p-methylstyrene, o-methylstyrene, m-methylstyrene, α-methylstyrene, and a fluorene skeleton-containing monomer. “o-”, “m-”, and “p-” are abbreviations for “ortho-”, “meta-”, and “para-”, respectively. Examples of the unsaturated carboxylic acid aminoalkyl ester include aminoethyl acrylate. Examples of the unsaturated carboxylic acid glycidyl ester include glycidyl acrylate and glycidyl methacrylate. Examples of the carboxylic acid vinyl ester include vinyl acetate and vinyl propionate. Examples of the vinyl cyanide compound include acrylonitrile, methacrylonitrile, and α-chloroacrylonitrile. Examples of the aliphatic conjugated diene include 1,3-butadiene and isoprene. Examples of the macromonomer include polystyrene, polymethylacrylate, polymethylmethacrylate, polybutylacrylate, polybutylmethacrylate, and polysilicone, each of which has an acryloyl group or a methacryloyl group at the terminal.

In addition, the acrylic resin preferably has an ethylenically unsaturated group in the side chain. Examples of the ethylenically unsaturated group include a vinyl group, an allyl group, an acrylic group, and a methacrylic group. As for a method of introducing an ethylenically unsaturated group into a side chain of an acrylic resin, in a case where the acrylic resin has a carboxy group, a hydroxy group, or the like, for example, there is a method of subjecting the acrylic resin to an addition reaction with an ethylenically unsaturated compound having an epoxy group, an acrylic acid chloride, a methacrylic acid chloride, or the like, or a method of adding a compound having an ethylenically unsaturated group to the acrylic resin using isocyanate.

Examples of the acrylic resin having an ethylenically unsaturated group in the side chain include “CYCLOMER” (registered trademark) P (ACA) Z250 (manufactured by Daicel-Allnex Ltd., 45% by mass solution of dipropylene glycol monomethyl ether, acid value: 110 mgKOH/g, weight-average molecular weight: 20,000).

Examples of the reactive monomer that can be used as the material for forming the matrix 36 of the microparticles 34 include oligomers such as bisphenol A diglycidyl ether (meth)acrylate, poly(meth)acrylate carbamate, modified bisphenol A epoxy (meth)acrylate, adipic acid 1,6-hexanediol (meth)acrylic acid ester, phthalic anhydride propylene oxide (meth)acrylic acid ester, trimellitic acid diethylene glycol (meth)acrylic acid ester, rosin-modified epoxy di(meth)acrylate, and alkyd-modified (meth)acrylate, tripropylene glycol di(meth)acrylate, 1,6-hexanediol di(meth)acrylate, bisphenol A diglycidyl ether di(meth)acrylate, trimethylolpropane tri(meth)acrylate, tetratrimethylolpropane tri(meth)acrylate, pentaerythritol tri(meth)acrylate, triacrylic formal, pentaerythritol tetra(meth)acrylate, dipentaerythritol hexa(meth)acrylate, dipentaerythritol penta(meth)acrylate, bisphenoxyethanol fluorene diacrylate, dicyclopentanedienyl diacrylate, alkyl-modified products thereof, alkyl ether-modified products thereof, and alkyl ester-modified products thereof. The reactive monomer may include two or more thereof.

From the viewpoint of being able to improve the compatibility with the light emitting material and improve the durability, the glass transition temperature (Tg) of the matrix is preferably 50° C. or higher, more preferably 70° C. or higher, still more preferably 80° C. or higher, and even still more preferably 90° C. or higher. In addition, from the viewpoint of being able to obtain an appropriate film hardness and suppress the occurrence of cracks and the like during film formation, Tg is preferably 200° C. or lower, more preferably 180° C. or lower, still more preferably 170° C. or lower, and even still more preferably 160° C. or lower. It is preferable that the Tg of the matrix resin is within the above range from the viewpoint of further improving the durability of the wavelength conversion member.

The glass transition temperature can be measured with a commercially available measuring device (for example, a differential scanning calorimeter (DSC7000X) manufactured by Hitachi High-Tech Science Corporation, heating rate: 10° C./min).

There is a strong relationship between the SP value, which is a solubility parameter of the matrix, and the emission peak wavelength of the organic light emitting material. In the matrix resin having a large SP value, the excited state of the organic light emitting material is stabilized by the interaction between the matrix resin and the organic light emitting material. Therefore, the emission peak wavelength of this organic light emitting material shifts to a long wavelength side as compared with the case of the matrix resin having a small SP value. Therefore, it is possible to optimize the emission peak wavelength of the organic light emitting material by dispersing the organic light emitting material in the matrix resin having an optimum SP value. By optimizing the emission peak wavelength of light emission of an organic light emitting material having high color purity, it is possible to reduce the density of a color filter and increase the brightness of a display, for example, in a case of being incorporated into a light source of the display as will be described later.

In a case where the SP value of the matrix is SP≤12.0 (cal/cm³)^{0.5}, the emission peak wavelength of red light is suppressed from becoming longer, and as a result, the difference between the emission peak wavelengths of green light and red light is reduced, which is therefore preferable. From the viewpoint of further increasing the effect, the SP value of the matrix is more preferably SP≤11.0 (cal/cm³)^{0.5} and still more preferably SP≤10.5 (cal/cm³)^{0.5}. In addition, a matrix having a lower limit value of SP≥7.0 (cal/cm³)^{0.5} has good dispersibility of the organic light emitting material, and thus can be suitably used. From the viewpoint of further increasing the effect, the SP value of the matrix is more preferably SP≥8.0 (cal/cm³)^{0.5}, still more preferably SP≥8.5 (cal/cm³)^{0.5}, and even still more preferably SP≥9.0 (cal/cm³)^{0.5}.

Here, the solubility parameter (SP value) is a value calculated from the types and ratios of monomers constituting the matrix using the Fedors estimation method described in [Poly. Eng. Sci., vol. 14, No. 2, pp. 147 to 154 (1974)] or the like, which is commonly used. The SP value for a mixture of a plurality of types of resins can also be calculated by the same method. For example, the SP value of polymethyl methacrylate can be calculated as 9.7 (cal/cm³)^{0.5} the SP value of polyethylene terephthalate (PET) can be calculated as 10.8 (cal/cm³)^{0.5}, and the SP value of a bisphenol A-based epoxy resin can be calculated as 10.9 (cal/cm³)^{0.5}.

In addition, the weight-average molecular weight (Mw) of the matrix is preferably 5,000 or more, more preferably 15,000 or more, and still more preferably 20,000 or more and is preferably 500,000 or less, more preferably 100,000 or less, and still more preferably 50,000 or less. In a case where the weight-average molecular weight is within the above range, a wavelength conversion member having good compatibility with a light emitting material and having higher durability can be obtained.

The method for synthesizing the matrix is not particularly limited, and a known method can be appropriately used. A commercially available product can also be used as the matrix.

Specific examples of the commercially available product include “OKP4” and “OKP-A1” (manufactured by Osaka Gas Chemicals Co., Ltd.), “DIANAL BR-83, BR-85, and BR-87” (manufactured by Mitsubishi Chemical Corporation), “VYLON 200, GK-360, UR-1400, and UR-4800” (manufactured by Toyobo Co., Ltd.), “OLYCOX KC-700 and KC-7000F” (manufactured by Kyoeisha Chemical Co., Ltd.), “NICHIGO POLYESTER TP-220, TP-294, and LP-033” (manufactured by Mitsubishi Chemical Corporation), “IUPIZETA EP-5000, OPTIMAS 7500, and OPTIMAS 6000” (manufactured by Mitsubishi Gas Chemical Company, Inc.), “ARON PE-1000, A-104, A-106, S-1001, S-1017, and S2060” (manufactured by Toagosei Co., Ltd.), “HI-PEARL M-4006 and M-4620” (manufactured by Negami Chemical Industrial Co., Ltd.), “ESTYRENE AS-30”, “ESTYRENE AS-61”, and “ESTYRENE AS-70” (manufactured by NIPPON STEEL Chemical & Material Co., Ltd.), and “SGP-10” (manufactured by PS Japan Corporation).

In addition to the matrix 36 and the pyrromethene derivative which is the pyrromethene derivative 38, the microparticles 34 may optionally contain a polymerization initiator, a viscosity modifier, a thixotropic agent, a hindered amine compound, an antioxidant, a light scattering agent, a polymer dispersant, a surfactant, and the like. For example, including a hindered amine compound in the microparticles 34 makes it possible to prevent the microparticles 34 from being colored by light of high illuminance.

A known method can be used as the method for forming the microparticles. The method for forming the microparticles is roughly divided into “break-down”, in which a bulk material is pulverized into fine particles, and “build-up”, in which fine particles are generated by controlling the growth of an aggregate of molecules through a chemical reaction.

Specific methods for break-down (that is, pulverization) include a “wet method” and a “dry method”. The wet method has many advantages in view of the fact that the dry method has a large pulverization limit particle diameter and further in terms of productivity. For this reason, wet pulverization is considered to be effective in a case of generating microparticles by break-down. In the wet pulverization, the “beads mill” is a device that can efficiently generate fine particles of submicron to several tens of nanometers.

On the other hand, in build-up, particles are formed by nucleation and growth from an atomic or molecular aggregate substance through a chemical reaction of a solution, physical cooling, and the like. According to the initial state of the raw material, it is classified into three types: “gas phase process (gas phase method)”, “liquid phase process (liquid phase method)”, and “solid phase process (solid phase method)”. In the gas phase method, a solution is atomized by pressurized jetting or the like and dried quickly to form solidified fine particles. Specific examples thereof include a spray drying method and a dropwise addition method. Among those methods, a spray drying method can be suitably used from the viewpoint of small particle diameter and excellent productivity. In addition, in the liquid phase method, a polymerizable composition dispersed or emulsified in a solution is polymerized with heat, light, or the like under stirring to form fine particles. Specific methods thereof include an emulsification polymerization method, a dispersion polymerization method, and a suspension polymerization method. From the viewpoint of excellent productivity, it is preferable to form the microparticles by a spray drying method, an emulsification polymerization method, or a suspension polymerization method.

The following method can be exemplified as an example of a specific embodiment of forming microparticles. The microparticles 34 are formed in such a manner that a pyrromethene derivative is added to and dispersed in a liquid compound to be the matrix 36 such as the (meth)acrylate monomer described above to prepare a dispersion liquid, the dispersion liquid is put into an aqueous solution in which a compound to be the binder 32 such as polyvinyl alcohol, which will be described later, is dissolved, and the compound to be the matrix 36 of the dispersion liquid is cured while stirring. The microparticles 34 may contain a polymerization initiator or the like.

The following method can also be exemplified as an example of a specific embodiment of forming microparticles. The microparticles 34 are formed in such a manner that a pyrromethene derivative and a solvent are added to and dispersed in a compound to be the matrix 36 such as the acrylic resin described above to prepare a dispersion liquid, and the dispersion liquid is jetted in the form of a spray from a spray nozzle and dried in a constant-temperature tank (dryer) connected to a nozzle outlet. In order to remove the residual solvent and the like, the obtained microparticles may be dried in another constant-temperature tank. In addition, the microparticles 34 may contain additives such as a light scattering particle and a polymerization initiator.

The particle diameter of the microparticles 34 is as described above. The average particle diameter of the microparticles 34 contained in the wavelength conversion layer is preferably 0.5 μm or more and 20 μm or less, and more preferably 1 μm or more and 15 μm or less.

It is preferable that the average particle diameter of the microparticles 34 is 0.5 μm or more (more preferably 1 μm or more) from the viewpoint that the microparticles 34 can be dispersed in the binder 32 without aggregation.

It is preferable that the average particle diameter of the microparticles 34 is 20 μm or less (more preferably 15 μm or less) from the viewpoint that it is possible to reduce the thickness of the wavelength conversion layer 26, suppress the sedimentation of the microparticles 34 in a coating liquid or the like which will be described later, and extend the pot life of the coating liquid or the like.

The particle diameter of the microparticles is obtained by taking a particle image using an optical microscope, a scanning electron microscope (SEM), or the like, analyzing the obtained image, and using the following expression. The same applies to the particle diameter of the light scattering particle which will be described later.

Particle diameter=(length of major axis+length of minor axis)/2

The average particle diameter of the microparticles can be obtained by the following method.

The wavelength conversion layer is cut using a microtome to form a cross section. The formed cross section is observed with an optical microscope (reflected light) to obtain a cross-sectional image. An arithmetic average of the particle diameters of 50 particles randomly selected in the obtained cross-sectional image can be taken as the average particle diameter of the microparticles contained in the wavelength conversion layer. Alternatively, the average particle diameter of the microparticles contained in the wavelength conversion layer can also be obtained by analyzing the obtained cross-sectional image with image analysis software (for example, ImageJ).

The content of the pyrromethene derivative in the microparticles 34 is not particularly limited and may be appropriately set according to the type of the pyrromethene derivative to be used, the particle diameter of the microparticles 34, and the like. In one embodiment, the content of the pyrromethene derivative in the microparticles 34 is preferably in a range of 0.01% to 20% by mass, more preferably in a range of 0.1% to 20% by mass, and still more preferably in a range of 0.1% to 10% by mass.

It is preferable that the content of the pyrromethene derivative in the microparticles 34 is 0.01% by mass or more from the viewpoint that a sufficient amount of the pyrromethene derivative 38 can be retained to enable high-brightness light emission, sufficient brightness can be obtained without making the wavelength conversion layer 26 unnecessarily thick, and the wavelength conversion member 16 can be made thinner.

It is preferable that the content of the pyrromethene derivative in the microparticles 34 is 20% by mass or less from the viewpoint that the pyrromethene derivative is suitably dispersed in the microparticles 34 without aggregation, enabling high-brightness light emission with a high quantum yield, and light loss due to self-absorption, maximum absorption, and the like of the pyrromethene derivative can be suppressed.

The surface of the microparticle may be subjected to an appropriate surface treatment in order to further increase reliability, particle dispersibility, transmittance, and the like. An example of the surface treatment may be a method of forming a coating layer impermeable to oxygen and/or moisture to increase the reliability. However, the surface treatment method is not limited thereto.

A layer having low permeability to moisture and/or oxygen and being transparent in a visible light range is preferably used as the coating layer. Examples of suitable materials for the coating layer include a metal oxide and a metal nitride, specific examples of which include silicon dioxide SiO₂ and aluminum oxide Al₂O₃. However, the materials for the coating layer are not limited thereto. Any known method such as a plating method, a physical vapor deposition (PVD) method, a chemical vapor deposition (CVD) method, or an atomic layer deposition (ALD) method can be used as the method for forming the coating layer. Among those methods, a PVD method and a CVD method are preferable from the viewpoint that a thin film can be uniformly formed on the surface of the microparticle, and a polygonal barrel sputtering method and a polygonal barrel plasma CVD method are more preferable from the viewpoint of excellent productivity.

From the viewpoint of increasing the dispersibility of the microparticles in the binder, it is preferable to appropriately control the solubility parameters (SP values) of the binder resin and the microparticle matrix. Specifically, from the viewpoint of preventing the elution of the microparticles in the binder, the SP value difference (ΔSP value) between the binder resin and the microparticle matrix is preferably ΔSP value>1.0 (cal/cm³)^{0.5}, more preferably ΔSP value>2.0 (cal/cm³)^{0.5} and still more preferably ΔSP value>3.0 (cal/cm³)^{0.5}. In addition, since aggregation of microparticles may occur in a case where the difference in the solubility parameter is too large, the upper limit value of the ΔSP value is preferably ΔSP value<20.0 (cal/cm³)^{0.5}, more preferably ΔSP value<17.0 (cal/cm³)^{0.5}, and still more preferably ΔSP value<16.0 (cal/cm³)^{0.5} By controlling the ΔSP value within the above range, elution and/or secondary aggregation of the microparticles can be prevented, and therefore good dispersibility of the microparticles tends to be obtained.

<Pyrromethene Derivative>

The pyrromethene derivative is preferably a compound represented by General Formula (1).

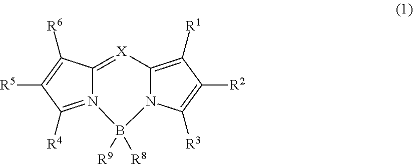

(In General Formula (1), X is C—R⁷ or N (nitrogen atom). R¹ to R⁹ may be the same as or different from each other, and are each independently selected from a hydrogen atom, an alkyl group, a cycloalkyl group, a heterocyclic group, an alkenyl group, a cycloalkenyl group, an alkynyl group, a hydroxy group, a thiol group, an alkoxy group, an alkylthio group, an aryl ether group, an aryl thioether group, an aryl group, a heteroaryl group, a halogen, a cyano group, an aldehyde group, a carbonyl group, a carboxy group, an ester group, a carbamoyl group, an amino group, a nitro group, a silyl group, a siloxanyl group, a boryl group, a sulfo group, a phosphine oxide group, and a fused ring and an aliphatic ring formed between adjacent substituents.)

It is preferable that X in General Formula (1) is C—R⁷ where R⁷ is a group represented by General Formula (2).

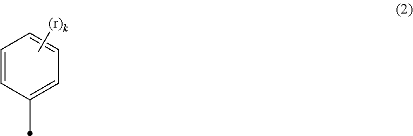

(In General Formula (2), r is selected from the group consisting of a hydrogen atom, an alkyl group, a cycloalkyl group, a heterocyclic group, an alkenyl group, a cycloalkenyl group, an alkynyl group, a hydroxy group, a thiol group, an alkoxy group, an alkylthio group, an aryl ether group, an aryl thioether group, an aryl group, a heteroaryl group, a halogen, a cyano group, an aldehyde group, a carbonyl group, a carboxy group, an ester group, a carbamoyl group, an amino group, a nitro group, a silyl group, a siloxanyl group, a boryl group, a sulfo group, and a phosphine oxide group. k is an integer in a range of 1 to 3. In a case where k is 2 or more, r's may be the same as or different from each other.)

In General Formula (1), at least one of R¹, R², . . . , or R⁶ is preferably an electron-withdrawing group. Preferred examples of the electron-withdrawing group include a fluorine atom, a fluorine-containing aryl group, a fluorine-containing heteroaryl group, a fluorine-containing alkyl group, a substituted or unsubstituted acyl group, a substituted or unsubstituted ester group, a substituted or unsubstituted amide group, and a substituted or unsubstituted sulfonyl group or cyano group.

In General Formula (1), either one of R⁸ or R⁹ is preferably a cyano group.

In addition to the above compound, pyrromethene derivatives described in WO2019/146332A, WO2016/190238A, WO2018/101129A, WO2017/002707A, and WO2020/045242A are preferably used.

Examples of the compound represented by General Formula (1) are shown below. However, the compound represented by General Formula (1) is not limited thereto.

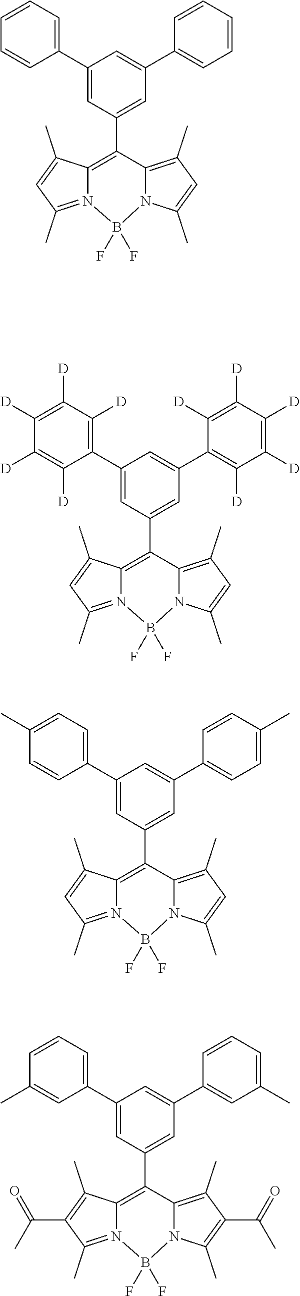

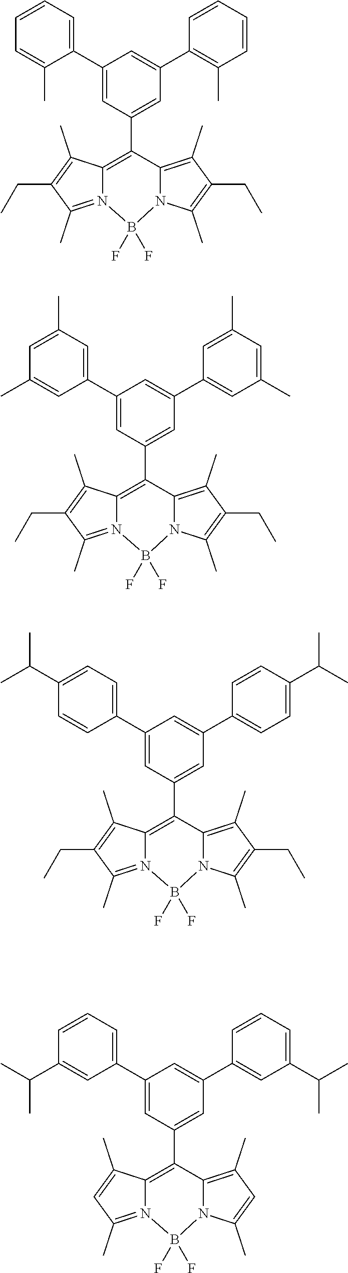

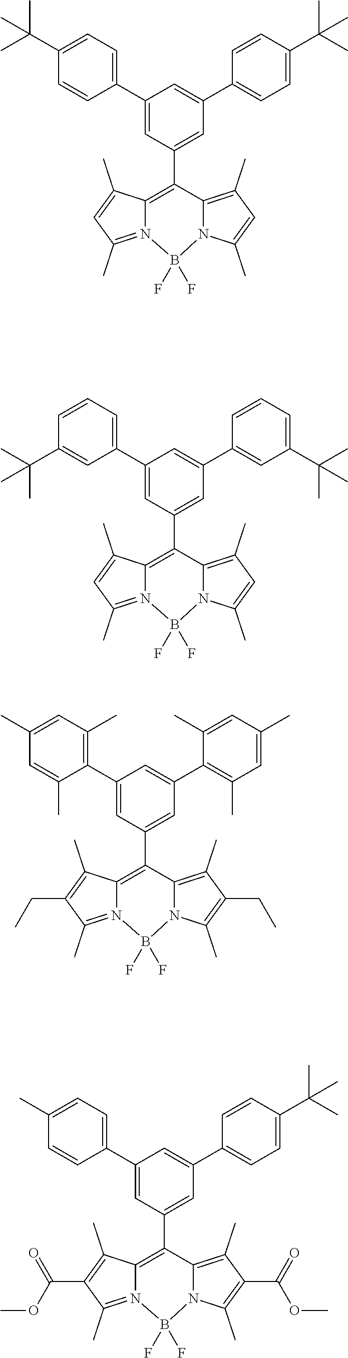

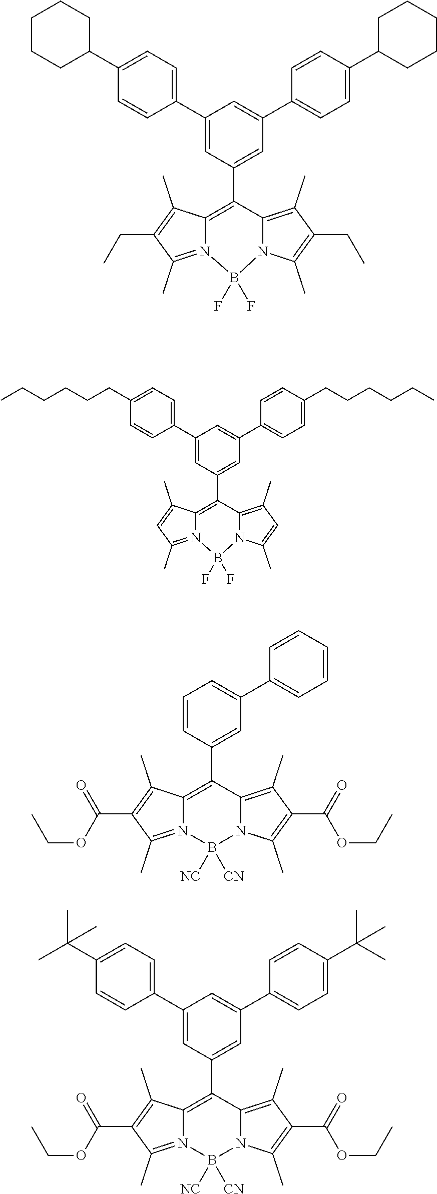

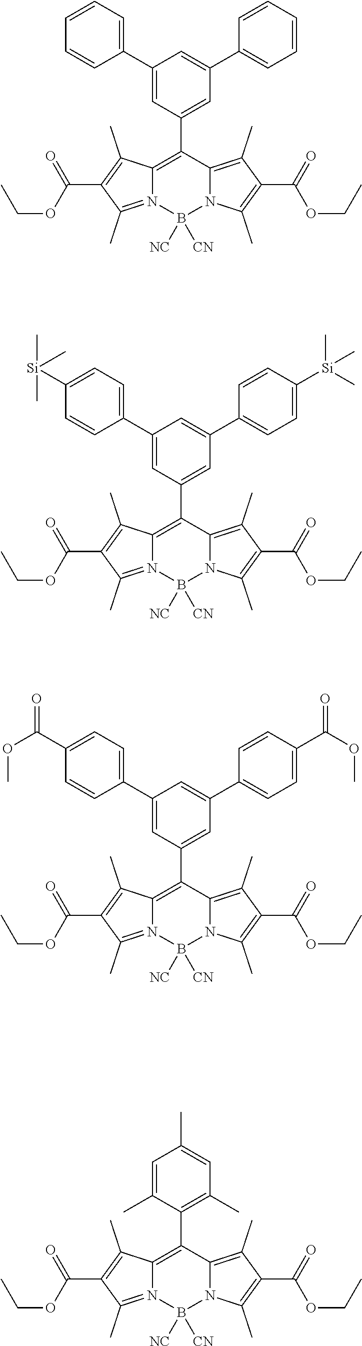

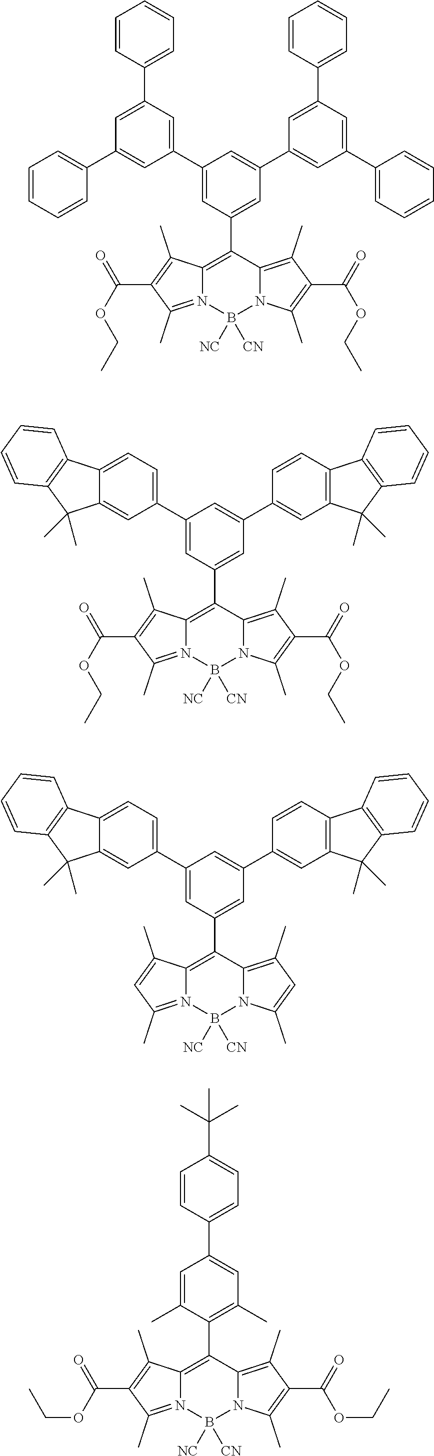

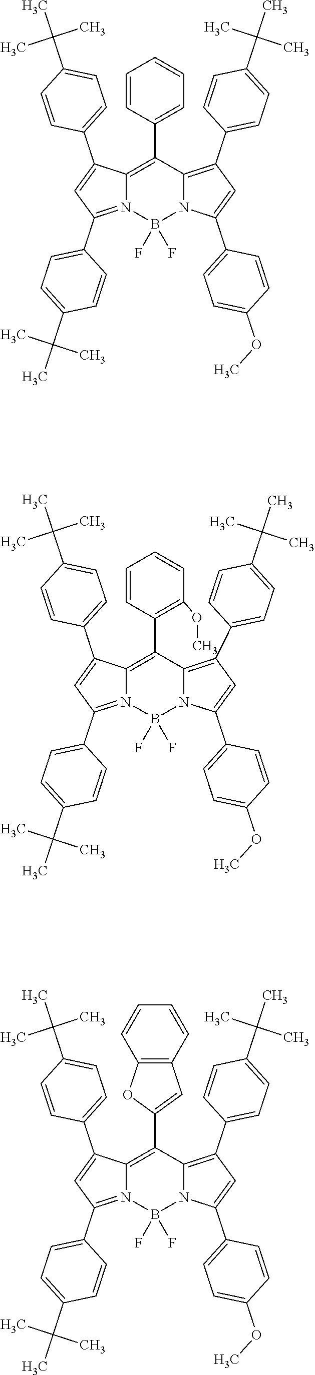

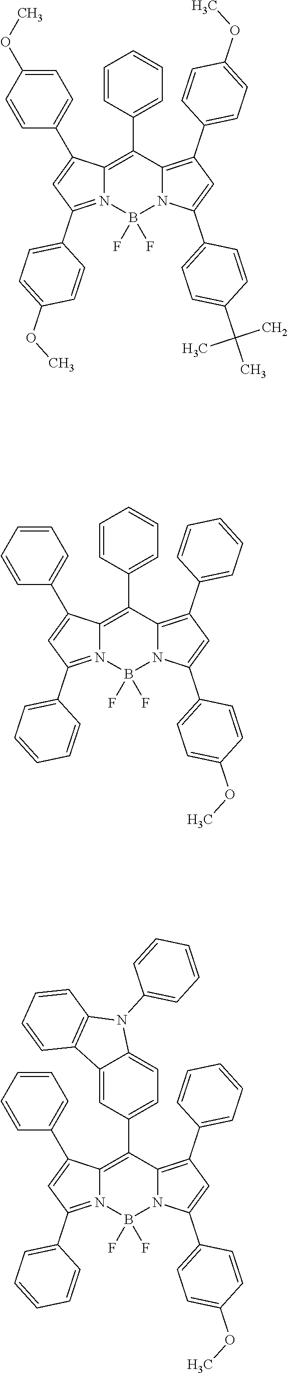

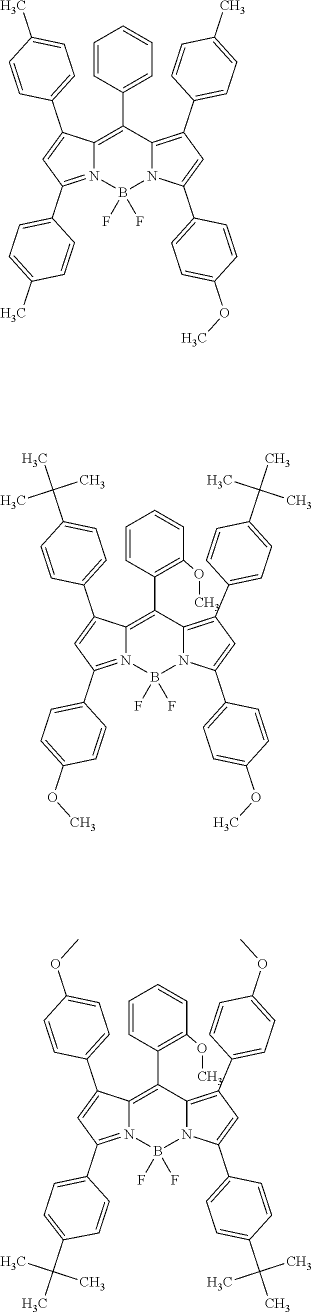

The compound represented by General Formula (1) can be synthesized with reference to the methods described in JP1996-509471A (JP-H8-509471A), JP2000-208262A, [J. Org. Chem., vol. 64, No. 21, pp. 7813 to 7819 (1999)], [Angew. Chem., Int. Ed. Engl., vol. 36, pp. 1333 to 1335 (1997)], and the like.

The wavelength conversion layer can appropriately contain other compounds, if necessary, in addition to the compound represented by General Formula (1). For example, an assist dopant such as rubrene may be contained in order to further increase the efficiency of energy transfer from excitation light to the compound represented by General Formula (1). In addition, in a case where it is desired to add a luminescence wavelength other than the luminescence wavelength of the compound represented by General Formula (1), a desired organic light emitting material, for example, a compound such as a coumarin-based light emitting material, a perylene-based light emitting material, a phthalocyanine-based light emitting material, a stilbene-based light emitting material, a cyanine-based light emitting material, a polyphenylene-based light emitting material, a rhodamine-based light emitting material, a pyridine-based light emitting material, a pyrromethene-based light emitting material, a porphyrin-based light emitting material, an oxazine-based light emitting material, or a pyrazine-based light emitting material can be added. In addition to these organic light emitting materials, it is also possible to add a combination of known light emitting materials such as an inorganic phosphor, a fluorescent pigment, a fluorescent dye, and a quantum dot.

In one embodiment, the pyrromethene derivative of the first example contained in the wavelength conversion layer is preferably a pyrromethene derivative exhibiting light emission by using excitation light, in which a peak wavelength is observed in a region of 500 nm or more and 580 nm or less. That is, the wavelength conversion layer preferably has a wavelength conversion layer containing the following light emitting material (a). The light emitting material (a) is a light emitting material exhibiting light emission by using excitation light in a wavelength range of 400 nm or more and 500 nm or less, in which a peak wavelength is observed in a region of 500 nm or more and 580 nm or less. Hereinafter, the light emission in which a peak wavelength is observed in a region of 500 nm or more and 580 nm or less is referred to as “green wavelength light emission”.

In addition, in one embodiment, the pyrromethene derivative of the second example contained in the wavelength conversion layer is preferably a pyrromethene derivative exhibiting light emission by using excitation light, in which a peak wavelength is observed in a region of 580 nm or more and 750 nm or less. That is, the wavelength conversion layer preferably has a wavelength conversion layer containing the following light emitting material (b). The light emitting material (b) is a light emitting material exhibiting light emission in which a peak wavelength is observed in a region of 580 nm or more and 750 nm or less by being excited by at least one of excitation light in a wavelength range of 400 nm or more and 500 nm or less or light emission from the light emitting material (a). Hereinafter, the light emission in which a peak wavelength is observed in a region of 580 nm or more and 750 nm or less is referred to as “red wavelength light emission”.

In addition, in one embodiment, it is preferable that the wavelength conversion member contains the light emitting material (a) and the light emitting material (b). That is, it is preferable that the wavelength conversion member includes a wavelength conversion layer containing the light emitting material (a) (green wavelength conversion layer) and a wavelength conversion layer containing the light emitting material (b) (red wavelength conversion layer). In addition to this point, it is preferable that at least one of the light emitting material (a) or the light emitting material (b) is the pyrromethene derivative. It should be noted that only one type of the light emitting material (a) may be used alone, or a plurality of types of the light emitting materials (a) may be used in combination. Similarly, only one type of the light emitting material (b) may be used alone, or a plurality of types of the light emitting materials (b) may be used in combination.

In a case where both the light emitting material (a) exhibiting green light emission and the light emitting material (b) exhibiting red light emission are contained, a part of the green light emission is converted into red light emission, so a content wa of the light emitting material (a) and a content wb of the light emitting material (b) preferably have a relationship of wa≥wb, and the content ratio of each material is wa:wb=preferably 1000:1 to 1:1, more preferably 500:1 to 2:1, and still more preferably 200:1 to 3:1. wa and wb are mass percent with respect to the mass of the wavelength conversion layer.

A part of the excitation light in a wavelength range of 400 nm or more and 500 nm or less usually transmits through a portion of the wavelength conversion member other than the wavelength conversion layer (for example, a concave portion where the wavelength conversion layer is not formed) without transmitting through the wavelength conversion layer. Therefore, the transmitted partial excitation light itself can be used as blue wavelength light emission. Therefore, in a case where the wavelength conversion member contains the light emitting material (a) exhibiting green wavelength light emission and the light emitting material (b) exhibiting red wavelength light emission in each wavelength conversion layer, and a blue wavelength light source that emits blue wavelength light with a sharp emission peak (for example, a blue wavelength organic EL element or a blue wavelength LED) is used as a light source, a sharp emission spectrum is exhibited at each of blue, green, and red wavelengths, which makes it possible to obtain white wavelength light having good wavelength purity.

<Light Scattering Particles>

The wavelength conversion member may contain light scattering particles. The light scattering particles may be contained in a binder or may be contained in a matrix. From the viewpoint of ease of forming the microparticles, it is preferable that the light scattering particles are contained in the binder.

The light scattering particle is a particle having a particle diameter of 0.1 μm or more. From the viewpoint of the scattering effect, the particle diameter of the light scattering particle is preferably in a range of 0.5 to 15.0 μm and more preferably in a range of 0.7 to 12.0 μm.

In addition, two or more types of light scattering particles having different particle diameters may be mixed and used in order to further improve the brightness and/or adjust the distribution of the brightness with respect to the viewing angle. In a case where a particle whose particle diameter is large is referred to as a particle having a large particle diameter, and a particle whose particle diameter is smaller than that of the particle having a large particle diameter is referred to as a particle having a small particle diameter, the particle having a large particle diameter preferably has a particle diameter in a range of 5.0 μm to 15.0 μm and more preferably in a range of 6.0 μm to 12.0 μm, from the viewpoint of imparting external scattering properties and imparting anti-Newton ring properties. In addition, the particle having a small particle diameter preferably has a particle diameter in a range of 0.5 μm to 5.0 μm and more preferably in a range of 0.7 μm to 3.0 μm, from the viewpoint of imparting internal scattering properties. In addition, the microparticles may also serve as light scattering particles.

The haze of the wavelength conversion member is a value measured in accordance with JIS K 7136:2000. An example of the measuring device is a haze meter NDH2000 (manufactured by Nippon Denshoku Industries Co., Ltd.). From the viewpoint of increasing the amount of emitted light, the wavelength conversion member desirably has a high haze and preferably has a haze of 30% or more, more preferably 40% or more, and still more preferably 50% or more. From the viewpoint of suppressing a decrease in transmittance, the haze is preferably 98% or less.

The light scattering particle may be an organic particle, an inorganic particle, or an organic-inorganic composite particle. For example, a synthetic resin particle can be used as the organic particle. Specific examples of the synthetic resin particle include a silicone resin particle, an acrylic resin particle (polymethylmethacrylate (PMMA)), a nylon resin particle, a styrene resin particle, a polyethylene resin particle, a urethane resin particle, and a benzoguanamine resin particle, among which a silicone resin particle and an acrylic resin particle are preferable from the viewpoint of availability of a particle having a suitable refractive index. In addition, a particle having a hollow structure can also be used. Examples of the inorganic particle include particles of, for example, single-component metals such as tungsten, zirconium, titanium, platinum, bismuth, rhodium, palladium, silver, tin, and gold; barium sulfate; metal oxides such as silica, talc, clay, kaolin, alumina white, titanium oxide, magnesium oxide, barium oxide, aluminum oxide, bismuth oxide, zirconium oxide, and zinc oxide; metal carbonates such as magnesium carbonate, barium carbonate, bismuth subcarbonate, and calcium carbonate; metal hydroxides such as aluminum hydroxide; composite oxides such as barium zirconate, calcium zirconate, calcium titanate, barium titanate, and strontium titanate; and metal salts such as bismuth subnitrate. From the viewpoint of being more excellent in the effect of improving external quantum efficiency, the light scattering particle preferably contains at least one selected from the group consisting of titanium oxide, alumina, zirconium oxide, zinc oxide, calcium carbonate, barium sulfate, barium titanate, and silica, and more preferably contains at least one selected from the group consisting of titanium oxide, zirconium oxide, zinc oxide, and barium titanate.

The shape of the light scattering particle can be any shape such as a spherical shape, a filamentous shape, or an amorphous shape. It is preferable to use a particle having less directionality in shape (for example, a spherical particle or a regular tetrahedral particle) as the light scattering particle, from the viewpoint that the uniformity, fluidity, and light scattering properties of the composition for forming a wavelength conversion layer can be further improved.

At least a part of the surface of the inorganic particle may be covered with other components such as an inorganic substance such as alumina, silica, zinc oxide, titanium oxide, or zirconium oxide, and an organic substance such as stearic acid or polysiloxane. For example, 50 area % or more of the surface of the light scattering particle may be covered with other components, or the entire surface of the light scattering particle may be covered with other components. In this case, the light scattering particle can also be referred to as a surface-treated light scattering particle.

As a method of covering at least a part of the surface of the light scattering particle with alumina (that is, surface-treating with alumina), for example, a wet treatment method (for example, a method of adding an aluminum salt aqueous solution to a slurry of light scattering particles and neutralizing the solution to adsorb alumina on the surfaces of the light scattering particles) can be mentioned. Commercially available products such as “MPT-141”, “CR-50”, “CR-50-2”, “CR-58”, “CR-58-2”, “CR-60”, “CR-60-2”, and “CR-97” (manufactured by Ishihara Sangyo Kaisha, Ltd.), “MT-700B”, “JR-405”, “JR-603”, “JR-605”, “JR-701”, “JR-805”, and “JR-806” (manufactured by Tayca Corporation), “Ti-pure R-706” (manufactured by The Chemours Company), “ST-705SA”, “ST-710EC”, and “ST-750EC” (manufactured by Titan Kogyo, Ltd.), and “D-918” and “D-970” (manufactured by Sakai Chemical Industry Co., Ltd.) can also be used as the light scattering particle.

A large difference in refractive index between the light scattering particle and the matrix of the wavelength conversion layer is preferable from the viewpoint of the scattering effect. From this point, a refractive index difference Δn between the light scattering particle and the matrix is preferably 0.02 or more, more preferably 0.10 or more, and still more preferably 0.20 or more. In the present invention and the present specification, the refractive index indicates a value n_{D} measured by a D line (589 nm).

From the viewpoint of the light scattering properties of the wavelength conversion layer and the viewpoint of the brittleness of the wavelength conversion layer, the content of the light scattering particles in the wavelength conversion layer is preferably 0.5% by volume or more, more preferably 10% by volume or more and 70% by volume or less, and still more preferably 20% by volume or more and 60% by volume or less.

<Polymer Dispersant>

The composition for forming a wavelength conversion layer may contain a polymer dispersant in order to improve the dispersion stability of the light scattering particles. The polymer dispersant is a polymer compound having a weight-average molecular weight of 750 or more and containing a functional group with an affinity for light scattering particles. The polymer dispersant has a function of dispersing light scattering particles. The polymer dispersant is adsorbed to light scattering particles through the functional group with an affinity for light scattering particles, and the light scattering particles can be dispersed in the composition for forming a wavelength conversion layer by electrostatic repulsion and/or steric repulsion between the polymer dispersants. The polymer dispersant preferably binds to the surface of the light scattering particle to be adsorbed to the light scattering particle.

Examples of the functional group with an affinity for light scattering particles include an acidic functional group, a basic functional group, and a non-ionic functional group. The acidic functional group has a dissociative proton and may be neutralized with a base such as an amine or a hydrate ion. The basic functional group may be neutralized with an acid such as an organic acid or an inorganic acid.

<Other Additives>

In addition to the pyrromethene derivative, the binder, and the matrix, the wavelength conversion member may contain other additives, for example, an antioxidant, a processing and heat stabilizer, a light resistance stabilizer such as an ultraviolet absorbent, a dispersant for stabilizing a coating film, a leveling agent, a plasticizer, a crosslinking agent such as an epoxy compound, a curing agent such as an amine, an acid anhydride, or imidazole, an adhesion aid such as a silane coupling agent as a modifier for the surface of members, silica particles as a sedimentation inhibitor for a pyrromethene derivative or the like, inorganic particles such as silicone fine particles, light scattering particles, and a silane coupling agent.

Examples of the antioxidant include phenolic antioxidants such as 2,6-di-tert-butyl-p-cresol and 2,6-di-tert-butyl-4-ethylphenol. However, the antioxidant is not limited thereto. In addition, these antioxidants may be used alone or in combination of a plurality thereof.

Examples of the processing and heat stabilizer include phosphorus-based stabilizers such as tributylphosphite, tricyclohexylphosphite, triethylphosphine, and diphenylbutylphosphine. However, the processing and heat stabilizer is not limited thereto. In addition, these stabilizers may be used alone or in combination of a plurality thereof.

Examples of the light resistance stabilizer include benzotriazoles such as 2-(5-methyl-2-hydroxyphenyl)benzotriazole and 2-[2-hydroxy-3,5-bis(α,α-dimethylbenzyl)phenyl]-2H-benzotriazole. However, the light resistance stabilizer is not limited thereto. In addition, these light resistance stabilizers may be used alone or in combination of a plurality thereof.

From the viewpoint of not inhibiting the light from the light source and/or the light emission of the light emitting material, these additives preferably have a small light absorption coefficient in a visible light range. Specifically, these additives preferably have a molar absorption coefficient ε of 1,000 or less and more preferably 500 or less over the entire wavelength range of 400 nm or more and 800 nm or less. The molar absorption coefficient ε is still more preferably 200 or less and even still more preferably 100 or less.

In addition, a compound having a role as a singlet oxygen quencher can also be suitably used as the light resistance stabilizer. The singlet oxygen quencher is a material that traps and inactivates singlet oxygen, which is generated in a case where oxygen molecules are activated by the energy of light. The coexistence of the singlet oxygen quencher in the wavelength conversion layer makes it possible to prevent deterioration of the light emitting material due to singlet oxygen.

It is known that singlet oxygen is generated by the exchange of electrons and energy between a triplet excited state of a coloring agent such as Rose bengal or methylene blue and an oxygen molecule in a ground state.

The wavelength conversion member can carry out color conversion (that is, wavelength conversion) of light by exciting the pyrromethene derivative contained in the wavelength conversion layer with excitation light and emitting light having a wavelength different from that of the excitation light. Since this excitation-light emission cycle is repeated, the interaction between the generated excited species and oxygen contained in the wavelength conversion layer increases the probability of generating singlet oxygen. As a result, the probability of collision between the pyrromethene derivative and the singlet oxygen also increases, so that the deterioration of the pyrromethene derivative is likely to proceed.

The pyrromethene derivative is an organic light emitting material. The organic light emitting material is more susceptible to singlet oxygen than the inorganic light emitting material. In particular, the compound represented by General Formula (1) has higher reactivity with singlet oxygen than a compound having a fused aryl ring such as perylene and a derivative thereof, and exhibits a large effect of singlet oxygen on the durability thereof. Therefore, the durability of the compound represented by General Formula (1), which is excellent in emission quantum yield and color purity, can be improved by rapidly inactivating the generated singlet oxygen with the singlet oxygen quencher.

Examples of the compound having a role as the singlet oxygen quencher include a tertiary amine, a catechol derivative, and a nickel compound. However, the compound having a role as the singlet oxygen quencher is not limited thereto. In addition, these compounds (light resistance stabilizers) may be used alone or in combination of a plurality thereof

<Substrate>

Various film-like materials (sheet-like materials) used for known wavelength conversion members can be used as the substrate 28. In the present invention and the present specification, the film and the sheet are synonymous with each other. Various film-like materials that can support the wavelength conversion layer 26 and the composition for forming a wavelength conversion layer to be formed into the wavelength conversion layer 26 can be used as the substrate 28. The substrate 28 is preferably transparent, and for example, glass, a transparent inorganic crystalline material, or a transparent resin material can be used as the substrate 28. In addition, the substrate 28 may be rigid or flexible. Further, the substrate 28 may have an elongated shape that can be wound or a sheet shape that has been cut into predetermined dimensions in advance.

From the viewpoint of ease of thinning, ease of weight reduction, and suitability for flexibility, films consisting of various resin materials (polymer materials) are suitably used as the substrate 28.

Specifically, resin films consisting of polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, polymethyl methacrylate resin (PMMA), polycarbonate (PC), polyacrylate, polymethacrylate, polypropylene (PP), polystyrene (PS), ABS, cycloolefin copolymer (COC), cycloolefin polymer (COP), and triacetyl cellulose (TAC) are suitably exemplified.

In addition, gas barrier films in which a gas barrier layer exhibiting gas barrier properties is formed on these resin films can also be used as the substrate 28.

Here, the substrate 28 preferably has an oxygen permeability of 0.1 to 100 cc/(m²·day·atm) and more preferably 1 to 50 cc/(m²·day·atm). The SI unit of the oxygen permeability is [fm/(s·Pa)]. [cc/(m²·day·atm)] can be converted into the SI unit by means of “1 fm/(s·Pa)=8.752 cc/(m²·day·atm)”.

It is preferable that the oxygen permeability of the substrate 28 is 100 cc/(m²·day·atm) or less from the viewpoint that it is possible to suitably prevent deterioration of the pyrromethene derivative 38 due to oxygen, and it is possible to prevent deterioration of the binder 32.

In addition, a film having a low oxygen permeability, that is, a film having high gas barrier properties is a compact and high-density film or a film having a compact and high-density layer. Examples of such a film generally include those in which a layer consisting of a metal oxide or a metal nitride having a thickness of several tens to several hundred nm is formed on a film serving as a support. However, such a film having an inorganic substance may degrade the optical properties of the wavelength conversion member 16 due to light absorption of an inorganic layer or the like. In addition, methods such as chemical vapor deposition (CVD) and physical vapor deposition (PVD) are commonly used to form the inorganic layer. However, the film having an inorganic substance as described above is generally expensive due to the low production rate and the extremely high level of quality control of foreign matter and the like. On the other hand, setting the oxygen permeability of the substrate 28 to 0.1 cc/(m²·day·atm) or more is preferable from the viewpoint that it is possible to select a film or the like produced by a wet process such as a solution coating method or a spray coating method; it is not necessary to have a dense inorganic layer, so it is possible to prevent the deterioration of the optical properties of the wavelength conversion member 16 due to the substrate 28; and it is possible to reduce the cost of the wavelength conversion member 16.

In addition, if necessary, the substrate 28 can include one or more layers such as a hard coat layer, an anti-Newton ring layer, an antireflection layer, a low-reflection layer, and an antiglare layer, or together with (or in place of) one or more of these layers, one or more surface layers such as a light scattering layer, a primer layer, an antistatic layer, and an undercoat layer.

The wavelength conversion member 16 shown in FIG. 2 has a configuration in which the wavelength conversion layer 26 is sandwiched between the substrates 28 corresponding to both main surfaces of the wavelength conversion layer 26. However, the present invention is not limited thereto. That is, the wavelength conversion member 16 may have a configuration in which the substrate 28 is provided only on one main surface of the wavelength conversion layer 26. The main surface is a maximum surface of a layer, a film-like material, or the like. The wavelength conversion member 16 preferably has a configuration in which the wavelength conversion layer 26 is sandwiched between the substrates 28, from the viewpoint that the wavelength conversion layer 26 can be suitably protected, the pyrromethene derivative 38 can be prevented from being deteriorated by oxygen, and physical deformation such as curling and bending can be suppressed by increasing the stiffness of the wavelength conversion member 16.

In a case where the wavelength conversion layer 26 is sandwiched between the substrates 28, the two substrates may be the same as or different from each other.

In a case where the wavelength conversion layer 26 is sandwiched between the substrates 28 and then in a case where two substrates are different from each other, it is preferable that at least one of the two substrates 28 satisfies the above-mentioned oxygen permeability and it is more preferable that both of the two substrates 28 satisfy the above-mentioned oxygen permeability.

In addition, the thickness of the substrate 28 is preferably in a range of 5 to 150 μm, more preferably in a range of 10 to 70 μm, and still more preferably in a range of 15 to 55 μm. Setting the thickness of the substrate 28 to 5 μm or more is preferable from the viewpoint that the wavelength conversion layer 26 can be suitably held and protected, the pyrromethene derivative 38 can be prevented from being deteriorated by oxygen, and physical deformation such as curling and bending can be suppressed by increasing the stiffness of the wavelength conversion member 16. Setting the thickness of the substrate 28 to 150 μm or less is preferable from the viewpoint that the thickness of the entire wavelength conversion member 16 including the wavelength conversion layer 26 can be reduced.

The method of producing such a wavelength conversion member 16 is not particularly limited, and various known methods of producing a laminated film in which a layer exhibiting optical functions is sandwiched between resin films or the like or one surface of the layer exhibiting optical functions is supported by a resin film or the like can be used. The following method is exemplified as a preferred method of producing the wavelength conversion member 16.

A pyrromethene derivative is added to a liquid compound to be the matrix 36 such as an uncured (meth)acrylate monomer and if necessary, a polymerization initiator or the like is further added thereto, and the mixture is stirred to prepare a dispersion liquid in which the pyrromethene derivative is dispersed in the liquid compound to be the matrix 36. The content of the pyrromethene derivative in this dispersion liquid is the content of the pyrromethene derivative in the formed microparticles 34.

On the other hand, an aqueous solution of the binder is prepared by dissolving a compound to be the binder 32 such as PVA in water. It is preferable to use pure water or ion exchange water as the water. The concentration of the aqueous solution is not particularly limited and may be appropriately set depending on the compound to be the binder 32, the amount of the dispersion liquid to be added, which will be described later, and the like. The concentration of the aqueous solution is preferably 1% to 40% by mass and more preferably 5% to 20% by mass.

Next, the above-described dispersion liquid is added to the aqueous solution in which the binder 32 is dissolved in water and if necessary, an emulsifier or the like is further added thereto, and the mixture is stirred to prepare an emulsified liquid in which the dispersion liquid is dispersed and emulsified in the aqueous solution. As described above, the liquid compound to be the matrix 36 is usually hydrophobic, and the pyrromethene derivative is also hydrophobic. Furthermore, the binder 32 preferably has an oxygen permeability coefficient of 0.01 cc/(m²·day·atm) or less and is therefore hydrophilic. Therefore, the dispersion liquid is dispersed in the aqueous solution in the state of liquid droplets encompassing the pyrromethene derivative in the liquid droplets of the compound to be the matrix 36.

After preparing the emulsified liquid, the compound to be the matrix 36 in the dispersion liquid is cured (crosslinked or polymerized) by a method such as irradiation with ultraviolet rays or heating while stirring the emulsified liquid. As a result, a coating liquid (that is, a composition for forming a wavelength conversion layer) is prepared in which the microparticles 34 having the pyrromethene derivative 38 dispersed in the matrix 36 are formed and then dispersed and emulsified in the aqueous solution of the binder 32.

On the other hand, two substrates 28 such as PET films are prepared.

After the coating liquid is prepared and the substrates 28 are prepared, the coating liquid is applied onto one surface of one of the substrates 28, and the coating liquid is dried by heating to form the wavelength conversion layer 26.

A coating liquid for forming the above-described wavelength conversion layer 26G and a coating liquid for forming the above-described wavelength conversion layer 26R are sequentially applied and dried to produce the laminate 26Y.

Alternatively, a composition for forming a wavelength conversion layer containing the microparticles 34G and the microparticles 34R is applied and dried to form the wavelength conversion layer 26.

The method of applying the coating liquid is not particularly limited, and various known coating methods such as spin coating, die coating, bar coating, and spray coating can be used. The method of heating and drying the coating liquid is also not particularly limited, and various known methods of drying an aqueous solution, such as heating and drying using a heater, heating and drying using hot air, and heating and drying using both a heater and hot air, can be used.

After the wavelength conversion layer 26 (or the laminate 26Y) is formed, another substrate 28 is further laminated and bonded to the surface of the wavelength conversion layer 26 on which the substrate 28 is not laminated, whereby the wavelength conversion member 16 as shown in FIG. 2 can be produced. The bonding of the substrate 28 may be carried out by utilizing the adhesion or adhesiveness of the wavelength conversion layer 26, or may be carried out using a transparent pressure sensitive adhesive, a transparent pressure-sensitive adhesive sheet, a bonding agent such as an optical clear adhesive (OCA), a bonding layer, a bonding sheet, or the like, if necessary.

In a case of producing a wavelength conversion member in which the substrate 28 is provided only on one main surface of the wavelength conversion layer 26, the production of the wavelength conversion member may be finished at the time at which the coating liquid is dried by heating to form the wavelength conversion layer 26.

In the backlight unit 10, the light source 18 is disposed at a center position of a bottom surface inside the housing 14. The light source 18 is a light source for light emitted by the backlight unit 10.

Various known light sources can be used as the light source 18 as long as those light sources emit light having a wavelength that is wavelength-converted by the pyrromethene derivative 38 of the wavelength conversion member 16 (wavelength conversion layer 26).

Above all, a light emitting diode (LED) is suitably exemplified as the light source 18. In addition, as described above, a wavelength conversion layer formed by dispersing microparticles containing a pyrromethene derivative in a binder such as a resin is suitably used as the wavelength conversion layer 26 of the wavelength conversion member 16. Therefore, as the light source 18, a blue LED that emits blue light is particularly suitably used, and above all, a blue LED having a peak wavelength of 450 nm±50 nm is particularly suitably used.

In the backlight unit 10, the output of the light source 18 is not particularly limited and may be appropriately set according to the illuminance (brightness) and the like of light required for the backlight unit 10.

In addition, in the backlight unit 10, the number of light sources 18 may be one as shown in the illustrated example, or a plurality of light sources 18 may be provided.

The backlight unit 10 shown in FIG. 1 is a so-called direct type backlight unit. However, the present invention is not limited thereto, and can be suitably applied to a so-called edge light type backlight unit that uses a light guide plate.

In a case of an edge light type backlight unit, for example, the edge light type backlight unit may be configured in such a manner that one main surface of the wavelength conversion member 16 is disposed to face the light incident surface of the light guide plate, and the light source 18 is disposed on the opposite side of the light guide plate with the wavelength conversion member 16 interposed therebetween. In the edge light type backlight unit, a plurality of light sources 18 are usually disposed in the longitudinal direction of the light incident surface of the light guide plate, or a long light source is disposed so that the longitudinal direction of the light source coincides with the longitudinal direction of the light incident surface of the light guide plate.

<Barrier Film>

A barrier film may be appropriately used for the wavelength conversion member. Examples of the barrier film include metal oxide thin films and metal nitride thin films of inorganic oxides such as silicon oxide, aluminum oxide, titanium oxide, tantalum oxide, zinc oxide, tin oxide, indium oxide, yttrium oxide, and magnesium oxide, inorganic nitrides such as silicon nitride, aluminum nitride, titanium nitride, and silicon carbide nitride, mixtures thereof, and other elements added to these inorganic oxides, inorganic nitrides, and mixtures thereof, and films consisting of various resins such as a polyvinyl chloride resin, an acrylic resin, a silicone resin, a melamine resin, a urethane resin, a fluororesin, and a polyvinyl alcohol resin such as a saponified product of vinyl acetate.

Examples of the resin having barrier properties suitably used for the barrier film include resins such as polyester, polyvinyl chloride, nylon, polyvinyl fluoride, polyvinylidene chloride, polyacrylonitrile, polyvinyl alcohol, and an ethylene-vinyl alcohol copolymer, and mixtures of these resins. Among them, polyvinylidene chloride, polyacrylonitrile, an ethylene-vinyl alcohol copolymer, and polyvinyl alcohol have very low oxygen permeability coefficients, so a barrier film containing one or more of these resins is preferable. From the viewpoint of resistance to discoloration, the barrier film more preferably contains one or more of polyvinylidene chloride, polyvinyl alcohol, and an ethylene-vinyl alcohol copolymer, and from the viewpoint of reducing the environmental load, the barrier film particularly preferably contains polyvinyl alcohol or an ethylene-vinyl alcohol copolymer. These resins may be used alone or may be used in admixture with different resins. From the viewpoint of uniformity and cost of the barrier film, a barrier film consisting of a single resin is more preferable.

For example, a saponified product of polyvinyl acetate in which 98 mol % or more of an acetyl group is saponified can be used as the polyvinyl alcohol. In addition, for example, a saponified product of an ethylene-vinyl acetate copolymer having an ethylene content of 20% to 50% in which 98 mol % or more of an acetyl group is saponified can be used as the ethylene-vinyl alcohol copolymer.

In addition, a commercially available resin can be used, and a commercially available film can also be used. Specific examples of the commercially available product include polyvinyl alcohol resin PVA117 (manufactured by Kuraray Co., Ltd.), and ethylene-vinyl alcohol copolymer (“EVAL” (registered trademark)) resins L171B and F171B, and film EF-XL (manufactured by Kuraray Co., Ltd.).

An antioxidant, a curing agent, a crosslinking agent, a processing and heat stabilizer, a light resistance stabilizer such as an ultraviolet absorbent, or the like may be added to the barrier film as necessary within a range that does not excessively affect the light emission and durability of the wavelength conversion layer.

The thickness of the barrier film is not particularly limited. From the viewpoint of flexibility and/or cost of the entire wavelength conversion member, the thickness of the barrier film is preferably 100 μm or less. The thickness of the barrier film is more preferably 50 μm or less, and still more preferably 20 μm or less. Particularly preferably, the thickness of the barrier film is 10 μm or less. The thickness of the barrier film may be 1 μm or less. In this regard, from the viewpoint of ease of layer formation, the thickness of the barrier film is preferably 0.01 μm or more.

The barrier film may be provided on both surfaces of the wavelength conversion member, or may be provided only on one surface of the wavelength conversion member. In addition, an auxiliary layer having an antireflection function, an antiglare function, an antireflection antiglare function, a hard coat function (rub resistance function), an antistatic function, an antifouling function, an electromagnetic wave shielding function, an infrared cut function, an ultraviolet cut function, a polarization function, a toning function, or the like may be provided according to the functions required for the wavelength conversion member.

<Organic Layer>

The wavelength conversion member may be composed of only a substrate and a wavelength conversion layer or may be composed of only a substrate, a wavelength conversion layer, and a barrier film, and may have a configuration having one or more layers. An example of such a layer is an organic layer. The “organic layer” is a layer containing an organic substance as a main component. The organic layer can be a layer having an organic substance content of 50% by mass or more, 60% by mass or more, 70% by mass or more, 80% by mass or more, 90% by mass or more, 95% by mass or more, or 99% by mass or more. Alternatively, the organic layer can be a layer composed of only an organic substance. Here, the layer composed of only an organic substance refers to a layer containing only an organic substance, excluding impurities that are unavoidably incorporated during the production process. The organic layer may contain only one type of organic substance, or may contain two or more types of organic substances.

For the organic layer, reference can be made to paragraphs [0020] to [0042] of JP2007-290369A and paragraphs [0074] to [0105] of JP2005-096108A. In one embodiment, the organic layer can contain a cardo polymer. This leads to an increase in the adhesion to a layer adjacent to the organic layer, particularly the adhesion to an inorganic layer, which is preferable. For details of the cardo polymer, reference can be made to paragraphs [0085] to [0095] of JP2005-096108A.

In addition, an organic layer containing a (meth)acrylamide compound is also preferable as the organic layer. It is preferable to provide the organic layer containing a (meth)acrylamide compound between the barrier film and the wavelength conversion layer from the viewpoint of increasing the adhesion between these layers. In the present invention and the present specification, the “(meth)acrylamide compound” refers to a compound containing one or more (meth)acrylamide groups in one molecule. The “(meth)acrylamide group” is used to indicate one or both of an acrylamide group and a methacrylamide group. The acrylamide group is a monovalent group represented by “CH₂═CH—(C═O)—NH—”, and the methacrylamide group is a monovalent group represented by “CH₂═C(CH₃)—(C═O)—NH—”. The functionality in the “(meth)acrylamide compound” refers to the number of (meth)acrylamide groups contained in one molecule of this compound. With regard to the (meth)acrylamide compound, the “monofunctional” refers to that the number of (meth)acrylamide groups contained in one molecule is one, and the “polyfunctional” refers to that the number of (meth)acrylamide groups contained in one molecule is two or more. The (meth)acrylamide compound is preferably a polyfunctional (meth)acrylamide compound and more preferably a difunctional to tetrafunctional (meth)acrylamide compound. For specific examples of the (meth)acrylamide compound, reference can be made to, for example, paragraphs [0069] and [0070] of WO2019/004431A.

The organic layer containing a (meth)acrylamide compound can be formed of a polymerizable composition containing a (meth)acrylamide compound. The (meth)acrylamide compound is a polymerizable compound, and the polymerizable composition can contain one or more (meth)acrylamide compounds as the polymerizable compound. A known polymerization initiator can be contained in the polymerizable composition. The polymerization initiator is not particularly limited, and reference can be made to, for example, paragraph [0079] of WO2019/004431A.

The organic layer can be formed on the surface of the barrier film, on the surface of the substrate, or on the surface of the wavelength conversion layer by a known method as a film forming method using a polymerizable composition. The thickness of the organic layer is preferably in a range of 0.05 to 10.00 μm and more preferably in a range of 0.50 to 5.00 μm.

### EXAMPLES

Hereinafter, the present invention will be described in more detail with reference to Examples. The materials, amounts used, ratios, treatment details, treatment procedures, and the like shown in the Examples below can be changed as appropriate without departing from the spirit of the present invention. Therefore, the scope of the present invention should not be construed as being limited by the specific examples described below.

### Example 1

<Preparation of Dispersion Liquid A>

A toluene dispersion liquid having the following composition was prepared, and the obtained solution was heated using an evaporator at 40° C. under reduced pressure to remove toluene, thereby preparing a dispersion liquid in which a pyrromethene derivative was dispersed in a matrix.

Pyrromethene derivative G-1 (emission maximum: 530 nm) 1% by mass

Dicyclopentanyl acrylate (DCP) (FA-513AS, manufactured by Resonac Holdings Corporation) 97% by mass

Photopolymerization initiator (IRGACURE TPO, manufactured by BASF SE) 2% by mass

<Preparation of Dispersion Liquid B>

Dispersion liquid B was prepared in the same manner as the dispersion liquid A, except that, in the dispersion liquid A, the pyrromethene derivative G-1 was replaced with pyrromethene derivative R-1 (emission maximum: 630 nm) and the content thereof was set to 0.2% by mass.

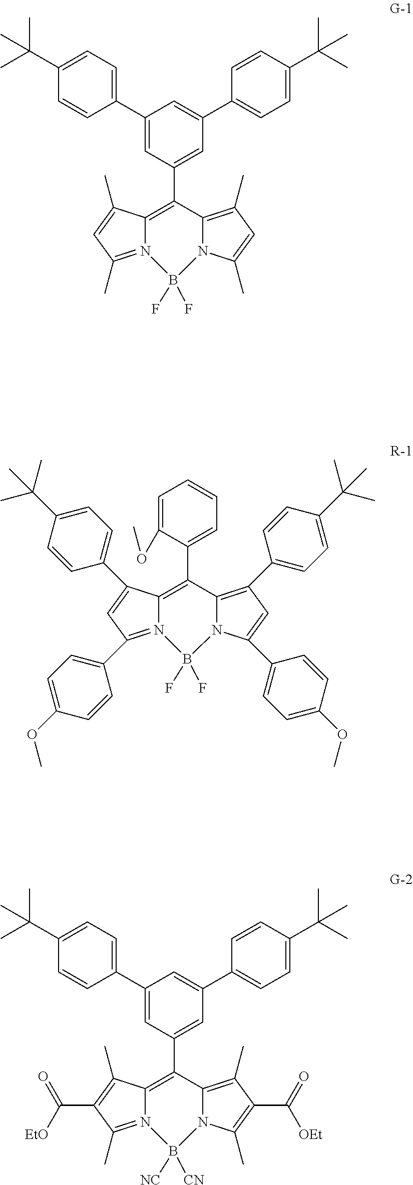

<Preparation of Binder Aqueous Solution>

PVA (partially saponified polyvinyl alcohol PVA 203, manufactured by Kuraray Co., Ltd., SP value=25.1 (cal/cm³)^{0.5}, degree of saponification=87 to 89 mol %, Mw=16,000) was prepared as a binder of a wavelength conversion layer.

The binder was put into pure water and dissolved by stirring while heating to a liquid temperature of 80° C. to prepare a binder aqueous solution in which the binder (PVA) was dissolved in the pure water. The concentration of the binder in the binder aqueous solution was set to 30% by mass.

The oxygen permeability coefficient of the binder was measured by the following procedure.

The prepared binder aqueous solution was applied onto a PET film (COSMOSHINE A4300, manufactured by Toyobo Co., Ltd., thickness: 50 μm), and dried by heating in a heating furnace at an internal furnace temperature of 95° C. for 30 minutes. The film thickness of the obtained coating film was 10 The coating film was peeled off from the PET film, and subjected to the measurement under conditions of a temperature of 25° C. and a relative humidity of 60% using a measuring device (OX-TRAN 2/21, manufactured by MOCON, Inc.) using a MOCON method. As a result, the oxygen permeability coefficient of the binder was a value shown in Table 1.

<Preparation of Emulsified Liquid a and Coating Liquid A>

A mixed liquid having the following composition was prepared using the prepared dispersion liquid A and binder aqueous solution.

Dispersion liquid A 5.8 parts by mass

Binder aqueous solution 93.7 parts by mass

1% by mass aqueous solution of sodium dodecyl sulfate (SDS, manufactured by Tokyo Chemical Industry Co., Ltd.) 0.5 parts by mass

50 ml of the mixed liquid having the above-described composition and a magnetic staller (hereinafter, referred to as “stirrer”) were put into a vial container having a diameter of 35 mm. All the preparation work of the mixed liquid was carried out in a glove box with an oxygen concentration of 300 parts per million (ppm) or less, and the vial container was capped in the glove box to maintain a state in which the inside was purged with nitrogen.

The vial container containing the mixed liquid and the stirrer was taken out from the glove box and stirred with the stirrer at 1,500 revolutions per minute (rpm) for 30 minutes to prepare an emulsified liquid A.

Next, while the emulsified liquid A was stirred to maintain the emulsified state, the entire emulsified liquid A was irradiated with ultraviolet rays using a 160 W/cm air-cooled metal halide lamp (manufactured by Eye Graphics Co., Ltd.) to cure the matrix (DCP) of the dispersion liquid to form microparticles. Thus, a coating liquid A in which the microparticles were dispersed and emulsified in the aqueous solution of the binder (PVA) was prepared. The irradiation time of ultraviolet rays was set to 120 seconds.

The matrix of the microparticles was cured under exactly the same conditions, and the oxygen permeability coefficient of the matrix was measured in the same manner as in the binder. As a result, the oxygen permeability coefficient of the matrix was 39 (cc·mm)/(m²·day·atm).

<Preparation of Emulsified Liquid B and Coating Liquid B>

An emulsified liquid B was prepared in the same manner as in the emulsified liquid A, except that, in the emulsified liquid A, the dispersion liquid A was replaced with the dispersion liquid B. Using the obtained emulsified liquid B, a coating liquid B was prepared in the same manner as in the coating liquid A.

<Production of Wavelength Conversion Member>

Two PET films (COSMOSHINE A4300, manufactured by Toyobo Co., Ltd.) having a thickness of 50 μm were prepared as substrates.

The prepared coating liquid A was applied onto one surface of one of the substrates using a die coater. Next, the coating liquid was dried in a heating furnace at an internal furnace temperature of 95° C. for 30 minutes to form a wavelength conversion layer A on the substrate. The thickness of the formed wavelength conversion layer A was 22 μm.

Next, the coating liquid B was applied onto the formed wavelength conversion layer A by a die coater to form a wavelength conversion layer B in the same manner as in the wavelength conversion layer A. The thickness of the formed wavelength conversion layer B was 13 μm.

The obtained wavelength conversion layer A was cut using a microtome to form a cross section, and in a case where the cross section was examined with an optical microscope (reflected light), microparticles in which a phosphor (pyrromethene derivative) was dispersed in a matrix were dispersed in the wavelength conversion layer. In addition, in a case where the optical microscope image obtained in this procedure was analyzed and measured by image analysis software (ImageJ), the average particle diameter of the microparticles was 5 μm, and the content of the microparticles in the wavelength conversion layer A was 17% by volume.

The other substrate (PET film) was laminated on the formed wavelength conversion layer B and bonded with a pressure sensitive adhesive (8172CL, manufactured by 3M Company), whereby a wavelength conversion member 101 as shown in FIG. 2 was produced, in which the wavelength conversion layer (laminate of the wavelength conversion layers A and B) was sandwiched between the two substrates.

### Example 2

The dispersion liquid A, the emulsified liquid A, and the coating liquid A were prepared to produce a wavelength conversion member 102 having the wavelength conversion layer A formed thereon in the same manner as in Example 1, except that, in Example 1, the pyrromethene derivative G-1 was replaced with pyrromethene derivative G-2.

### Example 3

A wavelength conversion member 103 was produced in the same manner as in Example 1, except that the binder of the wavelength conversion layer was changed from PVA (PVA203) to a butenediol-vinyl alcohol copolymer (BVOH, G POLYMER (AZF 8035W) manufactured by Mitsubishi Chemical Corporation).

In a case where the particle diameter of the microparticles was measured in the same manner as in Example 1, the average particle diameter of the microparticles was 5 μm. In addition, in a case where the oxygen permeability coefficient of the binder was measured in the same manner as in Example 1, the measured oxygen permeability coefficient of the binder was a value shown in Table 1.

### Example 4

A wavelength conversion member 104 was produced in the same manner as in Example 1, except that, in the preparation of the coating liquid, the emulsifier to be added was changed from SDS to BRIJ 30 (polyethylene glycol dodecyl ether, manufactured by Sigma-Aldrich Co. LLC, HLB value: 10.7) and the amount of the emulsifier added was such that the content of the emulsifier in the wavelength conversion layer was a value shown in Table 1.

In a case where the particle diameter of the microparticles was measured in the same manner as in Example 1, the average particle diameter of the microparticles was 9 μm.

### Example 5

A wavelength conversion member 105 was produced in the same manner as in Example 1, except that the PVA to be the binder of the wavelength conversion layer was changed from PVA203 to PVA505 (manufactured by Kuraray Co., Ltd.).

In a case where the particle diameter of the microparticles was measured in the same manner as in Example 1, the average particle diameter of the microparticles was 3 μm. In addition, in a case where the oxygen permeability coefficient of the binder was measured in the same manner as in Example 1, the measured oxygen permeability coefficient of the binder was a value shown in Table 1.

### Comparative Example 1

0.25 parts by mass of pyrromethene derivative G-1 and 300 parts by mass of toluene as a solvent were mixed with 100 parts by mass of polymethyl methacrylate (PMMA, manufactured by Kuraray Co., Ltd.) as a binder resin. Then, the mixture was stirred and defoamed for 20 minutes at 300 rpm using a planetary stirring and defoaming device “MAZERUSTAR” KK-400 (manufactured by Kurabo Industries Ltd.) to obtain a composition A for forming a wavelength conversion layer A. The oxygen permeability coefficient of PMMA was 6,000 (cc·mm)/(m²·day·atm).

Further, a composition B for producing a wavelength conversion layer B was obtained in the same manner as in the composition A, except that 0.03 parts by mass of pyrromethene derivative R-1 and 300 parts by mass of toluene as a solvent were mixed with 100 parts by mass of polymethyl methacrylate.

Next, the composition A was applied onto the PET film having a thickness of 50 μm using a slit die coater, heated in a heating furnace at an internal furnace temperature of 100° C. for 20 minutes, and dried to form a wavelength conversion layer A having an average film thickness of 15 μm. Further, the composition B was applied onto the wavelength conversion layer A and dried to form a wavelength conversion layer B having an average film thickness of 13 μm in the same manner as in the wavelength conversion layer A.

The substrate (PET film) was laminated on the formed wavelength conversion layer B and bonded with a pressure sensitive adhesive (8172CL, manufactured by 3M Company) to produce a wavelength conversion member 201 in which the wavelength conversion layers were sandwiched between the two substrates.

### Example 6

A wavelength conversion member 106 was produced in the same manner as in Example 1, except that, in Example 1, the binder was changed from PVA203 (partially saponified polyvinyl alcohol, manufactured by Kuraray Co., Ltd., SP value=25.1 (cal/cm³)^{0.5}, degree of saponification=87 to 89 mol %, Mw=16,000) to PVA103 (fully saponified polyvinyl alcohol, manufactured by Kuraray Co., Ltd., SP value=25.6 (cal/cm³)^{0.5}, degree of saponification=98 to 99 mol %, Mw=16,000), the emulsifier was changed from SDS to BRIJ30 (polyethylene glycol dodecyl ether, manufactured by Sigma-Aldrich Co. LLC, HLB value=10.7), and the amount of the emulsifier added was changed such that the content of the emulsifier in the wavelength conversion layer was a value shown in the table which will be given later. In a case where the oxygen permeability coefficient of the binder was measured in the same manner as in Example 1, the measured oxygen permeability coefficient of the binder was a value shown in the table which will be given later.

### Example 7

A wavelength conversion member 107 was produced in the same manner as in Example 6, except that, in Example 6, the emulsifier was changed from BRIJ30 to BRIJ35 (polyoxyethylene (23) lauryl ether, manufactured by Sigma-Aldrich Co. LLC, HLB value=16.9).

### Example 8

A wavelength conversion member 108 was produced in the same manner as in Example 6, except that, in Example 6, the emulsifier was changed from BRIJ30 to NIKKOL BC-2 (POE (2) cetyl ether, manufactured by Nikko Chemicals Co., Ltd., HLB value=6.4).

### Comparative Example 2

A wavelength conversion member 202 was produced in the same manner as in Example 6, except that, in Example 6, no emulsifier was added. In Comparative Example 2, no microparticles were formed, and phase separation was observed between the emulsified liquid and the binder aqueous solution.

### Comparative Example 3

A wavelength conversion member 203 was produced in the same manner as in Example 6, except that, in Example 6, the emulsifier was changed from BRIJ30 to NIKKOL MGO (glyceryl oleate, manufactured by Nikko Chemicals Co., Ltd., HLB value=2.5). In Comparative Example 3, microparticles (that is, particles having the particle diameter described above) were not obtained, and a large number of coarse particles were observed.

### Example 9

<Preparation of Dispersion Liquid 109G>

A methyl ethyl ketone dispersion liquid having the following composition was prepared to prepare a dispersion liquid 109G in which a pyrromethene derivative was dispersed in a matrix.
Pyrromethene derivative G-1 (emission maximum: 530 nm) 1.2% by mass
Polymethyl methacrylate (PMMA) (DIANAL BR-83, manufactured by Mitsubishi Gas Chemical Company, Inc., SP value=9.7 (cal/cm³)^{0.5} Mw=40,000) 28.8% by mass
Methyl ethyl ketone 69% by mass

<Preparation of Dispersion Liquid 109R>

Dispersion liquid 109R was prepared in the same manner as in the dispersion liquid 109G, except that, in the dispersion liquid 109G, the pyrromethene derivative G-1 was replaced with pyrromethene derivative R-1 and the content thereof was set to 0.2% by mass.

<Granulation of Microparticles>

The produced dispersion liquid 109G or 109R was stirred for 10 minutes and then granulated by a spray dryer (model DL-41, manufactured by Yamato Scientific Co., Ltd.). The operating conditions were set at an inlet temperature of 140° C. and an outlet temperature of 90° C., followed by drying and granulation with a dry air volume of 0.8 m³/min, a nozzle spray air pressure of 0.1 MPa, and a slurry feed rate of 20 g/min. The obtained granules were dried in air (90° C.) for 2 minutes. In a case where the obtained powder was observed with an optical microscope, it was confirmed that the microparticles 109G or 109R having a particle diameter of 3 μm in which the pyrromethene coloring agent was dispersed were formed.

<Preparation of Coating Liquid 109>

A coating liquid having the following composition was prepared to obtain a coating liquid 109.
Binder aqueous solution (produced by the same procedure as in Example 1) 96.9% by mass
Microparticles 109G 3% by mass
Microparticles 109R 0.1% by mass

<Production of Wavelength Conversion Member>

Two PET films (COSMOSHINE A4360, manufactured by Toyobo Co., Ltd.) having a thickness of 50 μm were prepared as substrates.

The prepared coating liquid 109 was applied onto one surface of one of the substrates using a die coater. Next, the coating liquid was dried in a constant-temperature tank (internal temperature of 90° C.) for 5 minutes to form a wavelength conversion layer 109 on the substrate. The thickness of the formed wavelength conversion layer 109 was 28 μm.

The obtained wavelength conversion layer 109 was cut using a microtome to form a cross section, and in a case where the cross section was examined with an optical microscope (reflected light), microparticles were dispersed in a matrix in the wavelength conversion layer. In addition, in a case where the optical microscope image obtained in this procedure was analyzed and measured by image analysis software (ImageJ), the average particle diameter of the microparticles was 3 μm, and the content of the microparticles in the wavelength conversion layer 109 was 10% by volume.

The other substrate (PET film) was bonded on the formed wavelength conversion layer 109 through a pressure sensitive adhesive (8172CL, manufactured by 3M Company), whereby a wavelength conversion member 109 as shown in FIG. 2 was produced, in which the wavelength conversion layer was sandwiched between the two substrates.

### Example 10

A wavelength conversion member 110 was produced in the same manner as in Example 9, except that, in Example 9, the matrix was changed from DIANAL BR-83 (polymethyl methacrylate, manufactured by Mitsubishi Gas Chemical Company, Inc.) to ESTYRENE AS-30 (acrylonitrile-styrene copolymer, manufactured by NIPPON STEEL Chemical & Material Co., Ltd., SP value=12.6 (cal/cm³)^{0.5}).

### Example 11

A wavelength conversion member 111 was produced in the same manner as in Example 9, except that, in Example 9, the matrix was changed from DIANAL BR-83 (polymethyl methacrylate, manufactured by Mitsubishi Gas Chemical Company, Inc.) to SGP-10 (polystyrene, manufactured by PS Japan Corporation, SP value=8.9 (cal/cm³)^{0.5}).

### Example 12

A wavelength conversion member 112 was produced in the same manner as in Example 9, except that, in Example 9, the binder was changed from PVA203 (partially saponified polyvinyl alcohol, manufactured by Kuraray Co., Ltd., SP value=25.1 (cal/cm³)^{0.5}, degree of saponification=87 to 89 mol %, Mw=16,000) to PVA103 (fully saponified polyvinyl alcohol, manufactured by Kuraray Co., Ltd., SP value=25.6 (cal/cm³)^{0.5}, degree of saponification=98 to 99 mol %, Mw=16,000).

### Example 13

A wavelength conversion member 113 was produced in the same manner as in Example 12, except that, in Example 12, a 1% by mass aqueous solution of emulsifier BRIJ30 (polyethylene glycol dodecyl ether, manufactured by Sigma-Aldrich Co. LLC, HLB value=10.7) was added to the coating liquid in an amount such that the content of the emulsifier in the wavelength conversion layer was a value shown in the table which will be given later.

### Comparative Example 4

<Preparation of Binder Aqueous Solution 204>

PVA (partially saponified polyvinyl alcohol PVA 203, manufactured by Kuraray Co., Ltd., SP value=25.1 (cal/cm³)^{0.5}, degree of saponification=87 to 89 mol %, Mw=16,000) was prepared as a binder of a wavelength conversion layer.

The binder was put into a mixed solution of pure water/methanol=70 parts by mass/30 parts by mass and dissolved by stirring while heating to a liquid temperature of 85° C. to prepare a binder aqueous solution in which the binder (PVA) was dissolved in the pure water/methanol. The concentration of the binder in the binder aqueous solution was set to 30% by mass.

<Preparation of Dispersion Liquids 204G and 204R>

Pyrromethene derivative dispersion liquids having the following composition were prepared to prepare dispersion liquids 204G and 204R in which the pyrromethene derivatives were dispersed.

(Dispersion Liquid 204G)
Pyrromethene derivative G-1 (emission maximum: 530 nm) 1.0% by mass
Methanol 99% by mass

(Dispersion Liquid 204R)
Pyrromethene derivative R-1 (emission maximum: 630 nm) 1.0% by mass
Methanol 99% by mass

<Preparation of Coating Liquid 204>

A coating liquid having the following composition was prepared to obtain a coating liquid 204.
Binder aqueous solution 204 6.9% by mass
Dispersion liquid 204G 3% by mass
Dispersion liquid 204R 0.1% by mass

<Production of Wavelength Conversion Member>

Two PET films (COSMOSHINE A4360, manufactured by Toyobo Co., Ltd.) having a thickness of 50 μm were prepared as substrates.

The prepared coating liquid 204 was applied onto one surface of one of the substrates using a die coater. Next, the coating liquid was dried in a constant-temperature tank (internal temperature of 90° C.) for 5 minutes to form a wavelength conversion layer 204 on the substrate. The thickness of the formed wavelength conversion layer 204 was 21 μm.

The obtained wavelength conversion layer 204 was cut using a microtome to form a cross section, and in a case where the cross section was examined with an optical microscope (reflected light), the wavelength conversion layer had no microparticles formed in the matrix, and the pyrromethene coloring agent was dispersed in the binder.

The other substrate (PET film) was bonded on the formed wavelength conversion layer 204 through a pressure sensitive adhesive (8172CL, manufactured by 3M Company), whereby a wavelength conversion member 204 as shown in FIG. 2 was produced, in which the wavelength conversion layer was sandwiched between the two substrates.

<Measurement of Initial Brightness>

A commercially available tablet terminal (trade name “Kindle (registered trademark) Fire HDX 7”, manufactured by Amazon.com, Inc.) provided with a blue light source in a backlight unit was disassembled, and the backlight unit was taken out. The wavelength conversion member of each of Examples or Comparative Examples cut into a rectangular shape (50×50 mm) was incorporated instead of the wavelength conversion member quantum dot enhancement film (QDEF) incorporated in the backlight unit. A backlight unit was produced in this manner.

The produced backlight unit was turned on so that the entire surface was displayed in white. An initial brightness value Y0 (cd/m²) was measured using a brightness meter (SR3, manufactured by Topcon Corporation) installed at a position of 520 mm in a direction perpendicular to the surface of the light guide plate, and evaluated based on the following evaluation standards.

—Evaluation Standards—

S: Y0≥545

A: 545>Y0≥530

B: 530>Y0≥515

C: 515>Y0≥500

D: 500>Y0

<Measurement of Durability>

The backlight unit was turned on for 1000 hours as it was from the measurement of the initial brightness, the brightness was measured in the same manner, and the obtained value was taken as a brightness value Y1 after the test.

From the initial brightness value Y0 and the brightness value Y1 after the test, the durability [%] was calculated by the following expression and evaluated based on the following evaluation standards.

Durability [%]=(Y1/Y0)×100

—Evaluation Standards—

S: durability≥97%

A: 97>durability≥95%

B: 95>durability≥90%

C: 90>durability≥80%

D: durability<80%

TABLE 1

| | | | | | Emulsifier | | | |
|---|---|---|---|---|---|---|---|---|
| | | | Binder | | | Content in | | |
| | | | | Oxygen permeability | | wavelength | | |
| | Pyrromethene | | | coefficient | | conversion layer | Evaluation | |
| | derivative | | Material | (cc · mm)/(m² · day · atm) | Material | [% by mass] | Brightness | Durability |
| Example 1 | G-1 | R-1 | PVA203 | 0.008 | SDS | 0.1 | A | A |
| Example 2 | G-2 | R-1 | PVA203 | 0.008 | SDS | 0.1 | A | A |
| Example 3 | G-1 | R-1 | BVOH | <0.001 | SDS | 0.1 | A | A |
| Example 4 | G-1 | R-1 | PVA203 | 0.008 | BRIJ 30 | 0.2 | A | A |
| Example 5 | G-1 | R-1 | PVA505 | 0.3 | SDS | 0.1 | A | B |
| Comparative | G-1 | R-1 | PMMA | 6000 | — | — | B | C |
| Example 1 | | | | | | | | |

As shown in Table 1, in the wavelength conversion members of Examples 1 to 5 in which the pyrromethene derivatives are dispersed in the form of microparticles in the wavelength conversion layer, mixing of pyrromethene derivatives with different light emission is suppressed even in a case where wavelength conversion layers are made into a laminate and therefore excellent emission color purity can be maintained, so that the brightness of white light is good. On the other hand, the member of Comparative Example 1, which does not use microparticles, cannot avoid mixing of pyrromethene derivatives due to interlayer movement thereof at the time of application and lamination, resulting in a decrease in brightness.

In addition, from the comparison of Examples 1 to 4 with Example 5, it can be confirmed that setting the oxygen permeability coefficient of the binder in which the microparticles are dispersed to 0.01 (cc·mm)/(m²·day·atm) or less is preferable in order to further improve the durability while maintaining the brightness.

TABLE 2

| | Microparticles 1 | | | | Microparticles 2 | | | |
|---|---|---|---|---|---|---|---|---|
| | | | | Average | | | Average | |
| | | | SP | particle | | SP | particle | |
| | Pyrromethene | Matrix | value | diameter | Pyrromethene | value | diameter | Binder |
| | derivative | Material | (cal/cm³) [symbol] | μm | derivative | (cal/cm³) [symbol] | μm | Material |
| Example 6 | G-1 | DCP | 8.3 | 3 | R-1 | 8.3 | 3 | PVA103 |
| Example 7 | G-1 | DCP | 8.3 | 5 | R-1 | 8.3 | 5 | PVA103 |
| Example 8 | G-1 | DCP | 8.3 | 2 | R-1 | 8.3 | 2 | PVA103 |
| Comparative | G-1 | DCP | 8.3 | Impossible | R-1 | 8.3 | Impossible | PVA103 |
| Example 2 | | | | to form | | | to form | |
| | | | | microparticles | | | microparticles | |
| Comparative | G-1 | DCP | 8.3 | Impossible | R-1 | 8.3 | Impossible | PVA103 |
| Example 3 | | | | to form | | | to form | |
| | | | | microparticles | | | microparticles | |

| | | | Emulsifier | | | | |
|---|---|---|---|---|---|---|---|
| | | | | | Content in | | |
| | Binder | | | | wavelength | | |
| | SP | Oxygen permeability | | | conversion | | |
| | value | coefficient | | HLB | layer | Evaluation | |
| | (cal/cm³) [symbol] | (cc · mm)/(m² · day · atm) | Material | value | [% by mass] | Brightness | Durability |
| Example 6 | 25.6 | 0.006 | BRIJ 30 | 10.7 | 0 01 | A | A |
| Example 7 | 25.6 | 0.006 | BRIJ 35 | 16.9 | 0.01 | A | A |
| Example 8 | 25.6 | 0.006 | NIKKOL | 6.4 | 0.01 | A | A |
| | | | BC-2 | | | | |
| Comparative | 25.6 | 0.006 | — | — | — | C | C |
| Example 2 | | | | | | | |
| Comparative | 25.6 | 0.006 | NIKKOL | 2.5 | 0.01 | B | C |
| Example 3 | | | MGO | | | | |

[symbol]

indicates data missing or illegible when filed

TABLE 3

| | Microparticles 1 | | | | Microparticles 2 | | | |
|---|---|---|---|---|---|---|---|---|
| | | | | Average | | | Average | |
| | | | SP | particle | | SP | particle | |
| | Pyrromethene | Matrix | value | diameter | Pyrromethene | value | diameter | Binder |
| | derivative | Material | (cal/cm³) [symbol] | μm | derivative | (cal/cm³) [symbol] | μm | Material |
| Example 9 | G-1 | BR-83 | 9.7 | 3 | R-1 | 9.7 | 3 | PVA203 |
| Example 10 | G-1 | AS-30 | 12.6 | 4 | R-1 | 12.6 | 4 | PVA203 |
| Example 11 | G-1 | SGP-10 | 8.9 | 4 | R-1 | 8.9 | 4 | PVA203 |
| Example 12 | G-1 | BR-83 | 9.7 | 3 | R-1 | 9.7 | 3 | PVA103 |
| Example 13 | G-1 | BR-83 | 9.7 | 3 | R-1 | 9.7 | 3 | PVA203 |
| Comparative | Without G-1 microparticles | | | | Without R-1 microparticles | | | PVA203 |
| Example 4 | | | | | | | | |

| | | | Emulsifier | | | | |
|---|---|---|---|---|---|---|---|
| | | | | | Content in | | |
| | Binder | | | | wavelength | | |
| | SP | Oxygen permeability | | | conversion | | |
| | value | coefficient | | HLB | layer | Evaluation | |
| | (cal/cm³) [symbol] | (cc · mm)/(m² · day · atm) | Material | value | [% by mass] | Brightness | Durability |
| Example 9 | 25.1 | 0.008 | — | — | — | [symbol] | A |
| Example 10 | 25.1 | 0.008 | — | — | — | [symbol] | A |
| Example 11 | 25.1 | 0.008 | — | — | — | A | A |
| Example 12 | 25.6 | 0.006 | — | — | — | [symbol] | [symbol] |
| Example 13 | 25.1 | 0.008 | BRIJ 30 | 10.7 | 0.01 | [symbol] | [symbol] |
| Comparative | 25.1 | 0.008 | — | — | — | D | A |
| Example 4 | | | | | | | |

[symbol]

indicates data missing or illegible when filed

One aspect of the present invention is useful in the technical field of a liquid crystal display device.

### EXPLANATION OF REFERENCES

10: backlight unit
14: housing
16: wavelength conversion member
18: light source
26: wavelength conversion layer
28: substrate
32: binder
34: microparticles
36: matrix
38: pyrromethene derivative

What is claimed is:

1. A wavelength conversion member comprising:
a wavelength conversion layer; and
a substrate,
wherein the wavelength conversion layer contains a binder and microparticles, and
the microparticles contain a pyrromethene derivative and a matrix.

2. The wavelength conversion member according to claim 1,
wherein an oxygen permeability coefficient of the binder is 0.01 (cc·mm)/(m²·day·atm) or less.

3. The wavelength conversion member according to claim 1,
wherein the wavelength conversion layer contains 0.01% to 5% by mass of an emulsifier.

4. The wavelength conversion member according to claim 2,
wherein the wavelength conversion layer contains 0.01% to 5% by mass of an emulsifier.

5. The wavelength conversion member according to claim 1,
wherein an average particle diameter of the microparticles is 1 μm or more and 15 μm or less.

6. The wavelength conversion member according to claim 2,
wherein an average particle diameter of the microparticles is 1 μm or more and 15 μm or less.

7. The wavelength conversion member according to claim 3,
wherein an average particle diameter of the microparticles is 1 μm or more and 15 μm or less.

8. The wavelength conversion member according to claim 4,
wherein an average particle diameter of the microparticles is 1 μm or more and 15 μm or less.

9. The wavelength conversion member according to claim 1,
wherein the wavelength conversion layer contains
microparticles 34G containing a pyrromethene derivative exhibiting light emission by using excitation light, in which a peak wavelength is observed in a region of 500 nm or more and 580 nm or less, and
microparticles 34R containing a pyrromethene derivative exhibiting light emission by using excitation light, in which a peak wavelength is observed in a region of 580 nm or more and 750 nm or less.

10. The wavelength conversion member according to claim 9,
wherein the wavelength conversion member includes a laminate 26Y of a wavelength conversion layer 26G containing the microparticles 34G and a wavelength conversion layer 26R containing the microparticles 34R.

11. The wavelength conversion member according to claim 9,
wherein the wavelength conversion member includes, as the wavelength conversion layer, a layer containing the microparticles 34G and the microparticles 34R in the same layer.

12. The wavelength conversion member according to claim 1,
wherein an average particle diameter of the microparticles is 1 μm or more and 15 μm or less, and
the wavelength conversion layer contains
microparticles 34G containing a pyrromethene derivative exhibiting light emission by using excitation light, in which a peak wavelength is observed in a region of 500 nm or more and 580 nm or less, and
microparticles 34R containing a pyrromethene derivative exhibiting light emission by using excitation light, in which a peak wavelength is observed in a region of 580 nm or more and 750 nm or less.

13. The wavelength conversion member according to claim 12,
wherein the wavelength conversion member includes a laminate 26Y of a wavelength conversion layer 26G containing the microparticles 34G and a wavelength conversion layer 26R containing the microparticles 34R.

14. The wavelength conversion member according to claim 12,
wherein the wavelength conversion member includes, as the wavelength conversion layer, a layer containing the microparticles 34G and the microparticles 34R in the same layer.

15. The wavelength conversion member according to claim 13,
wherein the wavelength conversion layer contains 0.01% to 5% by mass of an emulsifier.

16. The wavelength conversion member according to claim 14,
wherein the wavelength conversion layer contains 0.01% to 5% by mass of an emulsifier.

17. A method for producing a wavelength conversion member, comprising:
applying a composition containing microparticles 34G containing a pyrromethene derivative exhibiting light emission by using excitation light, in which a peak wavelength is observed in a region of 500 nm or more and 580 nm or less, onto a substrate to form a wavelength conversion layer 26G, and
applying a composition containing microparticles 34R containing a pyrromethene derivative exhibiting light emission by using excitation light, in which a peak wavelength is observed in a region of 580 nm or more and 750 nm or less, onto the wavelength conversion layer 26G to form a wavelength conversion layer 26R and form a laminate 26Y.

18. A light emitting device comprising:
the wavelength conversion member according to claim 1; and
a light source.

19. The light emitting device according to claim 18,
wherein the light source is selected from the group consisting of a blue light emitting diode and an ultraviolet light emitting diode.

20. A liquid crystal display device comprising:
the light emitting device according to claim 18; and
a liquid crystal cell.
